(19) United States
(12) Patent Application Publication
(10) Pub. No.: US 2012/0231150 A1
(43) Pub. Date: Sep. 13, 2012

(54) Digestive Enzyme Inhibitor and Methods of Use

(75) Inventors: Xian-Zhong Han, Decatur, IL (US); Rohit A. Medhekar, Decatur, IL (US); Andrew J. Hoffman, West Point, IN (US)

(73) Assignee: TATE & LYLE INGREDIENTS AMERICAS, LLC, Decatur, IL (US)

(21) Appl. No.: 13/414,212

(22) Filed: Mar. 7, 2012

Related U.S. Application Data
(60) Provisional application No. 61/450,365, filed on Mar. 8, 2011.

(51) Int. Cl. A23L 1/0522; C08B 31/12

(52) U.S. Cl. 426/661; 536/111

(57) ABSTRACT

The present invention provides for a digestive enzyme inhibitor comprising the hydrolysis products of an α-amylase hydrolyzed hydroxypropyl substituted starch. The present invention further provides for a food or beverage ingredient composition comprising the hydrolysis products of an α-amylase hydrolyzed hydroxypropyl substituted starch and a rapidly digestible starch, a food or beverage comprising such ingredient, and methods of use thereof, including a method of controlling postprandial glucose release after ingestion of a rapidly digestible starch.

### CROSS REFERENCE TO RELATED APPLICATIONS

This application claims the benefit of U.S. Provisional Patent Application No. 61/450,365, filed Mar. 8, 2011, which is incorporated herein by reference in its entirety.

### STATEMENT REGARDING FEDERALLY SPONSORED RESEARCH OR DEVELOPMENT

Not Applicable.

### BACKGROUND

Starches can be classified as rapidly digestible starch (RDS), slowly digestible starch, and resistant starch, related to physiological effects after consumption (Englyst et al., Eur. J. Clin. Nutri. 1992, 46 Suppl. 2, S30-S50). Most of the starch products consumed today have been cooked and are readily digestible. This availability results in high glycemic index (GI) and leads to elevated blood sugar levels. A high glycemic load or glycemic spike is typically followed by a hypoglycemic “overshoot,” i.e., dip in blood glucose, through the action of insulin released by the pancreas. Hypoglycemia is commonly associated with feelings of hunger. When hunger is followed by consumption of rapidly digestible carbohydrates, a vicious cycle of eating, followed shortly thereafter by feelings of hunger can ensue.

High GI foods have been shown in rats to induce nonreversible insulin resistance (Byrnes et al., J. Nutr. 1995, 125, pp 1430-37), stimulate fatty acid synthase and lipogenesis (Kabir et al., J. Nutr. 1998, 128, 1878-83), and promote body fat deposit (Pawlak et al., J. Nutr. 2001, 131, 99-104). In obese teenagers, the rapid absorption of glucose after consumption of high GI meals was shown to induce a sequence of hormonal and metabolic changes that promoted excessive food intake (Ludwig et al., Pediatrics 1999, 103, E261-E266).

The digestion of starch to glucose requires several enzymatic degradation steps. The α-1,4 endoglucosidases of salivary and pancreatic α-amylases hydrolyze starch into soluble α-dextrins. The α-dextrins are converted into glucose by the combined action of mucosal maltase-glucoamylase and sucrase-isomaltase. Maltase-glucoamylase and sucrase-isomaltase display α-1,4 exoglucosidic activity on the non-reducing ends of the α-limit dextrins and release glucose (Ao et al., FEBS Letters 2007; 581: 2381-388).

Controlling blood sugar levels by making cooked starches less readily digestible has been a major challenge for food scientists. Sustained release carbohydrate (SRC) compounds are ingredients or substances that can delay the release or absorption of glucose after consumption, resulting in blood glucose levels to be maintained above baseline for a period of time.

For diabetic patients, currently the most effective way of controlling blood sugar levels is taking the synthetic drug acarbose. Acarbose is an SRC compound and an effective inhibitor of digestive enzymes such as glucoamylase and α-amylase and thus reduces the rate of digestion of starch products. Acarbose significantly lowers postprandial blood glucose measured 60, 90, and 120 minutes after a meal (Coniff et al., Diabetes Care 1995; 18: 817-24). In a dose-response profile of acarbose in older subjects with type 2 diabetes, it was concluded that the acute efficacy of acarbose is near maximal at 25 mg when the meal size does not exceed 483 kcal and contains only 61 g of carbohydrate (Moorandian et al., The American Journal of the Medical Sciences 2000; 319: 334-37). Acarbose is usually administered as a tablet and eaten with the first mouthful of the meal. Use of acarbose to control blood sugar levels, however, is associated with undesirable side effects such as gas, bloating, diarrhea, and in rare situations may cause yellowing of the eyes or skin, dark urine, stomach pain, and nausea.

Slow release of glucose from starch after a meal is the preferred route for long term human health and fitness. Low postprandial glucose levels is also important for those suffering from medical conditions such as diabetes and obesity. Thus, there remains a need to slow the digestion of starches in order to control blood sugar levels.

### SUMMARY OF THE INVENTION

The present invention provides for a food ingredient composition comprising (i) the hydrolysis products of an α-amylase hydrolyzed hydroxypropyl substituted starch and (ii) a rapidly digestible starch, wherein the hydroxypropyl substituted starch has at least about 5% hydroxypropyl substitution before hydrolysis, and wherein the ratio by weight on a dry solids basis of the hydrolysis products to the rapidly digestible starch is from about 20% to about 80% of the hydrolysis products to from about 80% to about 20% of rapidly digestible starch.

In certain embodiments of the food ingredient composition, the rapidly digestible starch of the food ingredient is selected from the group consisting of: cooked or gelatinized starches from corn, wheat, rice, potato, and tapioca; starches from flours of corn, wheat, rice, potato, and tapioca; and maltodextrin and dextrin. In certain embodiments, the rapidly digestible starch is a starch that can be converted to a cooked or gelatinized starch during food processing. In certain embodiments, the hydroxypropyl substituted starch is from corn. In certain embodiments, the hydroxypropyl substituted starch is a crosslinked starch. In certain embodiments, the hydroxypropyl substituted starch comprises at least about 30% fiber before hydrolysis. In certain embodiments, the hydroxypropyl substituted starch is a waxy starch that has about 13% hydroxypropyl substitution before hydrolysis. Further, in certain embodiments, a crosslinked hydroxypropyl substituted starch is a waxy starch that has about 10% hydroxypropyl substitution and about 2% crosslinking before hydrolysis.

The present invention also provide for a food product comprising (i) the hydrolysis products of an α-amylase hydrolyzed hydroxypropyl substituted starch and (ii) a rapidly digestible starch, wherein the hydroxypropyl substituted starch has at least about 5% hydroxypropyl substitution before hydrolysis, and wherein the ratio by weight on a dry solids basis of the hydrolysis products to the rapidly digestible starch in the food product is from about 20% to about 80% of the hydrolysis products to from about 80% to about 20% of rapidly digestible starch.

In certain embodiments of the food product, the rapidly digestible starch of the food product is selected from the group consisting of: cooked or gelatinized starches from corn, wheat, rice, potato, and tapioca; starches from flours of corn, wheat, rice, potato, and tapioca; and maltodextrin and dextrin. In certain embodiments, the rapidly digestible starch is a starch that can be converted to a cooked or gelatinized starch during food processing. In certain embodiments, the hydroxypropyl substituted starch is from corn. In certain embodiments, the hydroxypropyl substituted starch is a crosslinked starch. In certain embodiments, the hydroxypropyl substituted starch comprises at least about 30% fiber before hydrolysis. In certain embodiments, the hydroxypropyl substituted starch is a waxy starch that has about 13% hydroxypropyl substitution before hydrolysis. Further, in certain embodiments, a crosslinked hydroxypropyl substituted starch is a waxy starch that has about 10% hydroxypropyl substitution and about 2% crosslinking before hydrolysis.

The present invention also provides for methods of preparing a sustained release carbohydrate food ingredient composition, the method comprising combining the hydrolysis products of an α-amylase hydrolyzed hydroxypropyl substituted starch with a rapidly digestible starch, wherein the hydroxypropyl substituted starch has at least about 5% hydroxypropyl substitution before hydrolysis, and wherein the ratio by weight on a dry solids basis of the hydrolysis products to the rapidly digestible starch is from about 20% to about 80% of the hydrolysis products to from about 80% to about 20% of rapidly digestible starch.

In certain embodiments of the methods of preparing a sustained release carbohydrate food ingredient composition, the rapidly digestible starch is selected from the group consisting of: cooked or gelatinized starches from corn, wheat, rice, potato, and tapioca; starches from flours of corn, wheat, rice, potato, and tapioca; and maltodextrin and dextrin. In certain embodiments, the rapidly digestible starch is a starch that can be converted to a cooked or gelatinized starch during food processing. In certain embodiments, the hydroxypropyl substituted starch is from corn. In certain embodiments, the hydroxypropyl substituted starch is a crosslinked starch. In certain embodiments, the hydroxypropyl substituted starch comprises at least about 30% fiber before hydrolysis. In certain embodiments, the hydroxypropyl substituted starch is a waxy starch that has about 13% hydroxypropyl substitution before hydrolysis. Further, in certain embodiments, the crosslinked hydroxypropyl substituted starch is a waxy starch that has about 10% hydroxypropyl substitution and about 2% crosslinking before hydrolysis.

The present invention also provides for methods of preparing a food product, the method comprising including the hydrolysis products of an α-amylase hydrolyzed hydroxypropyl substituted starch and a rapidly digestible starch in a food product, wherein the hydroxypropyl substituted starch has at least about 5% hydroxypropyl substitution before hydrolysis, and wherein the ratio by weight on a dry solids basis of the hydrolysis products to the rapidly digestible starch in the food product is from about 20% to about 80% of the hydrolysis products to from about 80% to about 20% of rapidly digestible starch.

In certain embodiments of the methods of preparing a food product, the rapidly digestible starch is selected from the group consisting of: cooked or gelatinized starches from corn, wheat, rice, potato, and tapioca; starches from flours of corn, wheat, rice, potato, and tapioca; and maltodextrin and dextrin. In certain embodiments, the rapidly digestible starch is a starch that can be converted to a cooked or gelatinized starch during food processing. In certain embodiments, the hydroxypropyl substituted starch is from corn. In certain embodiments, the hydroxypropyl substituted starch is a crosslinked starch. In certain embodiments, the hydroxypropyl substituted starch comprises at least about 30% fiber before hydrolysis. In certain embodiments, the hydroxypropyl substituted starch is a waxy starch that has about 13% hydroxypropyl substitution before hydrolysis. Further, in certain embodiments, the crosslinked hydroxypropyl substituted starch is a waxy starch that has about 10% hydroxypropyl substitution and about 2% crosslinking before hydrolysis.

The present invention also provides for methods of controlling postprandial glucose released after ingestion of a rapidly digestible starch, the method comprising orally administering to a mammalian subject within thirty minutes of each other: (i) the hydrolysis products of an α-amylase hydrolyzed hydroxypropyl substituted starch and (ii) the rapidly digestible starch, wherein the hydroxypropyl substituted starch has at least about 5% hydroxypropyl substitution before hydrolysis, and wherein the ratio by weight on a dry solids basis of the hydrolysis products to the rapidly digestible starch ingested within thirty minutes of each other is from about 20% to about 80% of the hydrolysis products to from about 80% to about 20% of rapidly digestible starch. In certain embodiments, the hydrolysis products and rapidly digestible starch are administered together in the same food product.

The present invention also provides for a digestive enzyme inhibitor comprising the hydrolysis products of an α-amylase hydrolyzed hydroxypropyl substituted starch, wherein the hydroxypropyl substituted starch is a waxy corn starch comprising at least about 30% fiber before hydrolysis and wherein the hydroxypropyl substituted starch has about 13% hydroxypropyl substitution before hydrolysis.

The present invention also provides for a digestive enzyme inhibitor comprising the hydrolysis products of an α-amylase hydrolyzed hydroxypropyl substituted starch, wherein the hydroxypropyl substituted starch is a crosslinked waxy corn starch comprising at least about 30% fiber before hydrolysis and wherein the hydroxypropyl substituted starch has about 10% hydroxypropyl substitution and about 2% crosslinking before hydrolysis.

### BRIEF DESCRIPTION OF THE DRAWINGS

FIG. 1 shows in vitro digestion curves of the total starch (maltodextrin and sheared cross-linked HP starch) by α-amylase (AM) and amyloglucosidase (AMG).

FIG. 2 shows the percentage of starch digested at different acarbose concentrations (d.s. based).

FIG. 3 shows the percentage of starch digested at different concentrations of sheared cross-linked HP starch concentrations (total d.s. based).

FIG. 4 shows in vitro digestion curves of the maltodextrin (with the sheared cross-linked HP starch subtracted) by α-amylase (AM) and amyloglucosidase (AMG).

FIG. 5 shows in vitro digestion curves of the maltodextrin (with the sheared cross-linked HP starch subtracted) by amyloglucosidase (AMG) only.

FIG. 6 shows in vitro digestion curves of the total starch (maltodextrin and TERMAMYL® or GC358 hydrolyzed cross-linked HP starch) by α-amylase (AM) and amyloglucosidase (AMG).

FIG. 7 shows in vitro digestion curves of the maltodextrin (with TERMAMYL® or GC358 hydrolyzed cross-linked HP starch subtracted) by α-amylase (AM) and amyloglucosidase (AMG).

FIG. 8 shows the expected blood glucose concentration in a human body without considering metabolism (5 L blood in a 160 lb human adult consuming 75 g total CHO).

FIG. 9 shows the expected blood glucose concentration in a human body without considering metabolism (5 L blood in a 160 lb human adult consuming 75 g available CHO adjusted by 58% fiber in the cross-linked HP starch.

FIG. 10 shows reported plasma glucose concentrations following consumption of ground brown rice (GBR) with and without acarbose from the literature.

FIG. 11 shows the increments of plasma glucose from zero minutes after consumption of 75 g ground brown rice with acarbose from the literature.

FIG. 12 shows rates of increments of plasma glucose in 15 minutes and 30 minutes digestion after consumption of 75 g ground brown rice with acarbose.

FIG. 13 shows in vitro digestion curves of total starch (maltodextrin TERMAMYL® hydrolyzed and cross-linked HP starch) by α-amylase (AM) and amyloglucosidase (AMG).

FIG. 14 shows in vitro digestion curves of the maltodextrin (with the TERMAMYL® hydrolyzed cross-linked HP starch subtracted) by α-amylase (AM) and amyloglucosidase (AMG).

FIG. 15 shows an RVA plot of different percentages of TERMAMYL®-hydrolyzed cross-linked HP starch produced according to the scaled-up production method of Example 2.

FIG. 16 shows a chromatogram of α-amylase hydrolyzed cross-linked HP starch as determined by liquid chromatography (LC) with Aminex silver-form column.

FIG. 17 shows a chromatogram of α-amylase hydrolyzed cross-linked HP starch after in vitro digestion as determined by liquid chromatography (LC) with Aminex silver-form column.

FIG. 18 shows gel permeation chromatographic (GPC) profiles of α-amylase hydrolyzed cross-linked HP starch.

FIG. 19 shows high-performance anion-exchange chromatography (HPAEC) of α-amylase hydrolyzed cross-linked HP starch (sample 271266).

FIG. 20 shows high-performance anion-exchange chromatography (HPAEC) of α-amylase hydrolyzed cross-linked HP starch (sample 271267).

FIG. 21 shows high-performance anion-exchange chromatography (HPAEC) of α-amylase hydrolyzed cross-linked HP starch after in vitro digestion (sample 271268).

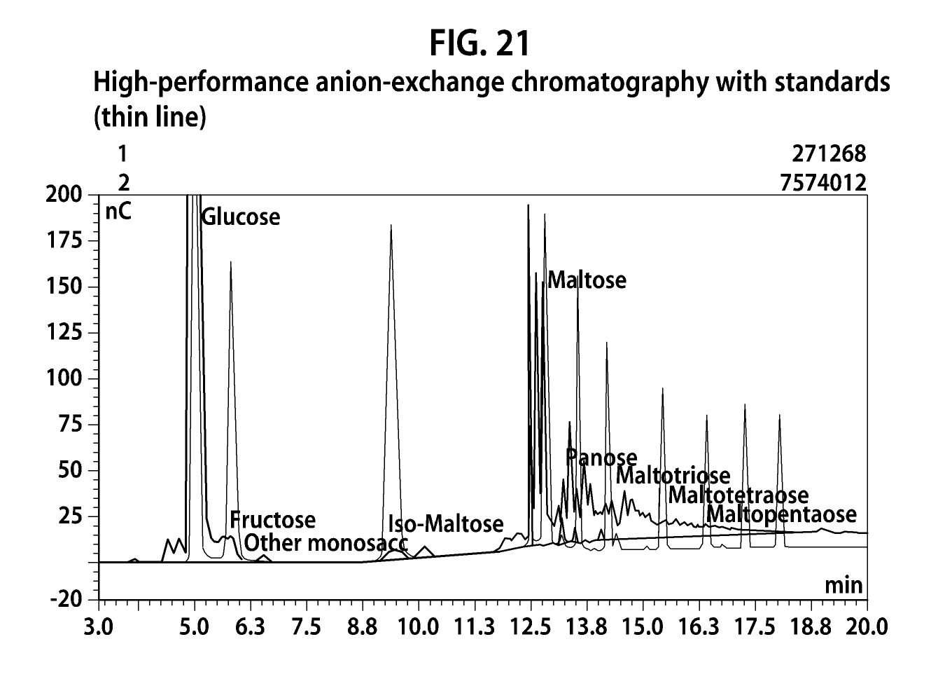

FIG. 22 shows high-performance anion-exchange chromatography (HPAEC) of α-amylase hydrolyzed cross-linked HP starch after in vitro digestion (sample 271269).

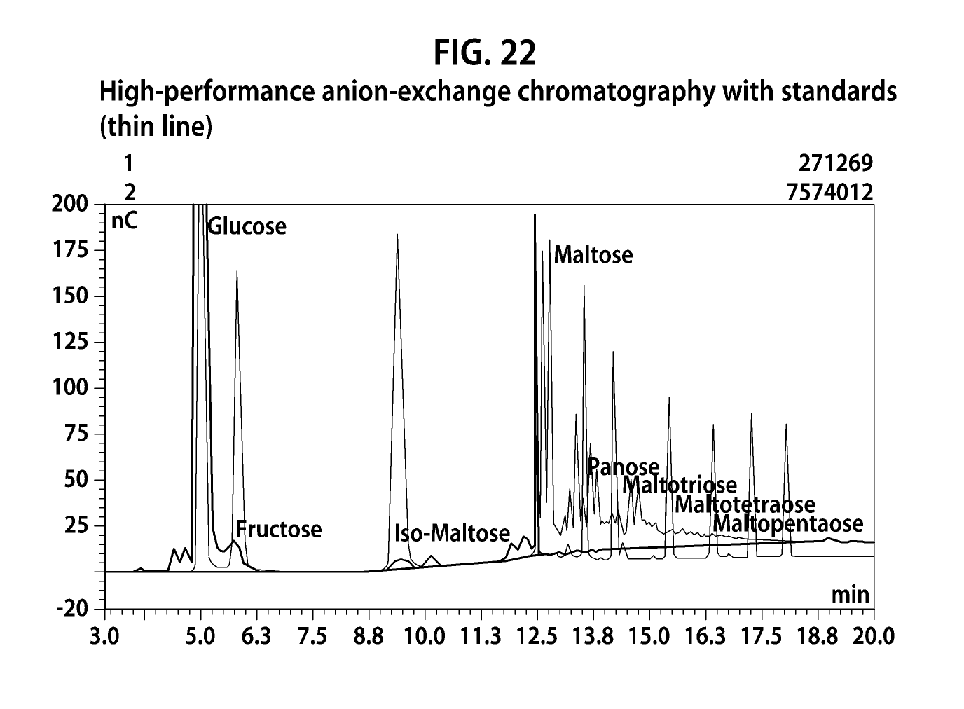

FIG. 23 shows the Total Ion Chromatograms (TICs) of sample 271269 and reference DP1-8 standard.

FIG. 24 shows the mass spectra of individual peaks at 15.11 minutes in the TIC of sample 271269.

FIG. 25 shows the mass spectra of individual peaks at 13.52 minutes in the TIC of sample 271269.

FIG. 26 shows the mass spectra of individual peaks at 11.71 minutes in the TIC of sample 271269.

FIG. 27 shows the mass spectra of individual peaks at 10.09 minutes in the TIC of sample 271269.

FIG. 28 shows the mass spectra of individual peaks at 8.31 minutes in the TIC of sample 271269.

FIG. 29 shows the mass spectra of individual peaks at 6.77 minutes in the TIC of sample 271269.

FIG. 30 shows in vitro digestion curves of maltodextrin (with the glucose from the HP starch subtracted).

FIG. 31 shows in vitro digestion curves of the mixture of maltodextrin and HP starch hydrolyzate.

FIG. 32 shows the glycemic response of 25 g TH-MS2000 and 25 g maltodextrin. Glycemic response from 25 g TH-MS2000 (mean±SEM; n=6) in a beverage compared to 25 g maltodextrin (mean±SEM; n=15).

FIG. 33 shows the effect of 10 g of TH-MS2000 on the glycemic response of 25 g maltodextrin in 14 volunteers. Glycemic response of 25 g maltodextrin+10 g TH-MS2000 (mean±SEM; n=14) compared to 25 g maltodextrin (mean±SEM; n=15).

FIG. 34 shows glycemic response curves for paired data for maltodextrin and maltodextrin+TH-MS2000. Paired data for glycemic response 25 g maltodextrin+10 t TH-MS2000 compared to 25 g maltodextrin (mean±SEM; n=9).

### DETAILED DESCRIPTION

Headings are provided herein solely for ease of reading and should not be interpreted as limiting.

### I. DEFINITIONS

As used herein, the term “sustained release carbohydrate (SRC),” is an ingredient or substance that can delay the release or absorption of glucose after consumption of digestible carbohydrates.

As used herein, the term “hydrolyzate” is used interchangeably to refer to the hydrolysis products of a starch.

As used herein, the term “food products” includes ingestible foods and beverages.

Concentrations, amounts, and other numerical data may be presented here in a range format (e.g., from 5% and 20%). It is to be understood that such range format is used merely for convenience and brevity and should be interpreted flexibly to include not only the numerical values explicitly recited as the limits of the range, but also to include all the individual numerical values or sub-ranges encompassed within that range, as if each numerical value and sub-range is explicitly recited. For example, a range of from 5% to 20% should be interpreted to include numerical values such as, but not limited to 5%, 5.5%, 9.7%, 10.3%, 15%, etc., and sub-ranges such as, but not limited to 5% to 10%, 10% to 15%, 8.9% to 18.9%, etc., in addition to any other values, sub-ranges, etc., provided for illustrative purposes.

### II. Overview

The present invention provides for hydrolyzates of certain hydroxypropyl substituted starches that inhibit the action of certain digestive enzymes. The hydrolyzates of the invention may act as sustained release carbohydrate ingredients and may lower postprandial blood glucose when consumed with starch products.

It was discovered that certain hydroxypropyl substituted starches (“HP starches”) are capable of inhibiting certain digestive enzymes in in vitro enzyme digestion assays. More particularly, it was determined that such HP starches are partially hydrolyzed by pancreatin and that the hydrolysis products then inhibit glucoamylase. Further studies were done by pre-hydrolyzing HP starches with various α-amylase enzymes. The resulting α-amylase-hydrolyzed products were then tested by in vitro enzyme inhibition assays. The α-amylase-hydrolyzed HP starch products inhibited the digestion of maltodextrin in in vitro enzyme inhibition assays and showed reduced glucose release, characteristic of a sustained release carbohydrate.

### III. Digestive Enzyme Inhibitor

It has been discovered that certain hydroxypropyl substituted starches, when hydrolyzed by an α-amylase to yield low molecular weight hydrolyzed products (hydrolyzate), can inhibit digestive enzymes, such as amyloglucosidase (AMG) (e.g., Example 1, Example 2, and Example 4). The hydrolyzate has a much lower viscosity than the non-hydrolyzed starch and is easier to incorporate into food products. Further, the hydrolyzate is water soluble and heat stable, which makes it suitable for use in a wide range of food products containing rapidly digestible starches.

The present invention provides for a method of inhibiting glucoamylase activity with a digestive enzyme inhibitor comprising the hydrolysis products of certain α-amylase hydrolyzed HP starches. An effective amount of the inhibitor is contacted with an enzyme with glucoamylase activity in the presence of a glucoamylase substrate. An effective amount is an amount of inhibitor that when contacted with a glucoamylase enzyme reduces the glucoamylase activity on a substrate by a measurable amount under the reactions conditions present. An effective amount for any given circumstance can be determined by enzymatic activity assays such as demonstrate in Example 1. When the inhibitor is administered to a subject, such as a human, an effective amount can be determined by measuring a physiological response, such as a noticeable reduction of the peak glycemic response or extension of elevated blood glucose after consuming the inhibitor with a rapidly digestible starch substrate in comparison to consuming only the substrate on the same total available carbohydrate base.

A. Starch

Numerous types of starches are known that can be used as a starting material for hydroxypropyl substitution. The particular starch chosen will depend on its performance, availability, cost, and the food product in which it is to be incorporated.

Suitable starches may be derived from a plant obtained by standard breeding techniques including crossbreeding, translocation, inversion, transformation, insertion, irradiation, chemical or other induced mutation, or any other method of gene or chromosome engineering to include variations thereof. In addition, starch derived from a plant grown from induced mutations and variations of the above generic composition which may be produced by known standard methods of mutation breeding are also suitable.

Starches can be described by source such as from cereals, tubers and roots, legumes, and fruits. Typical sources of starch include, but are not limited to corn, potato, sweet potato, wheat, tapioca, pea, banana, plantain, barley, oat, rye, triticale, sago, amaranth, arrowroot, canna, sorghum, and rice, including low amylose (waxy) and high amylose varieties thereof.

Starches may also be defined by certain properties. For example, a starch may be an “amylosic” or high amylose starch comprising substantially pure amylose, a high amylopectin starch, or natural or artificial mixtures of amylose and amylopectin (such as those containing at least 50% of amylose by weight). Starches may also comprise substantially less amylose, such as a non-waxy amylose-containing starch generally comprising about 25-30% amylose by weight.

Commercial starches often comprise some level of contamination with other types or sources of starch. For example, commercial waxy corn starch can contain several percent dent corn starch contamination. For example, a commercial waxy corn starch may comprise less than about 10% or less than about 7% dent starch due to contamination.

The starch material may also be any genetic variety of starch—such as ae or dull—known to one of skill in the art or of other starch types as described herein including those that are natural, genetically altered, or obtained from hybrid breeding. The starch material may also be a combination of different starches.

Starches may be modified by a variety of methods. Representative, non-limiting examples of chemically modified starches are hydroxypropylated starches, starch adipates, acetylated starches, phosphorylated starches, crosslinked starches, acetylated and organically esterified starches, phosphorylated and inorganically esterified starches, cationic, anionic, nonionic, and zwitterionic starches, and succinate and substituted succinate derivatives of starch. Such modifications are known in the art, for example in Modified Starches: Properties and Uses, Ed. Wurzburg, CRC Press, Inc., Florida (1986). Other suitable modifications and methods are disclosed in U.S. Pat. Nos. 4,626,288, 2,613,206 and 2,661,349. Modified starches may be thermally converted, fluidity or thin boiling type products derived from the aforementioned types of chemically modified starches.

Crosslinking may be conducted using methods widely known in the art, representative methods of which are described, for example, in Modified Starches: Properties and Uses, Ed. Wurzburg, CRC Press, Inc., Florida (1986). Starches can be chemically cross-linked using a variety of cross-linking agents. The Food and Drug Administration, however, regulates compositions and concentrations of chemicals used in food production. See 21 CFR §172.892(d), which limits either the reagent concentration during production or the phosphorous content of the finished product.

Thus, in certain embodiments, cross-linking agents are those selected from the group consisting of sodium trimetaphosphate (STMP), sodium tripolyphosphate (STPP), phosphoryl chloride, and mixtures thereof. One skilled in the art would appreciate that other cross-linking agents may be used with similar effect, and may be unregulated outside of the United States. For example, adipic acid and epichlorohydrin may be used.

B. Hydroxypropyl Substitution

The present invention provides for digestive enzyme inhibiting α-amylase-hydrolyzates of certain hydroxypropyl substituted starches. Suitable methods for hydroxypropylating starches include those described in U.S. Pat. No. 3,505,110, U.S. Pat. No. 3,577,407, U.S. Pat. No. 4,452,978, and U.S. Pat. No. 4,837,314, which are incorporated herein in their entireties. According to 21 C.F.R. §172.892 “Food starch-modified,” the amount of propylene oxide added during modification should not exceed 25% of starch. Therefore, the amount of hydroxypropyl substitution legally achievable is limited by this regulation. For example, 13% HP substitution has been achieved with the addition of 22% propylene oxide. Higher amounts of HP substitution, such as up to about 20%, up to about 25%, or higher are achievable, but may require levels of added propylene oxide that exceed the regulation.

In certain embodiments, the level of hydroxypropyl substitution is at least about 5%. In certain embodiments, the level of hydroxypropyl substitution is from about 5% to about 25%. In certain embodiments, the level of hydroxypropyl substitution is from about 5% to about 20%. In certain embodiments, the level of hydroxypropyl substitution is from about 5% to about 15%. In certain embodiments, the level of hydroxypropyl substitution is from about 5% to about 10%. In certain embodiments, the level of hydroxypropyl substitution is from about 10% to about 25%. In certain embodiments, the level of hydroxypropyl substitution is from about 10% to about 20%. In certain embodiments, the level of hydroxypropyl substitution is from about 10% to about 15%. In certain embodiments, the level of hydroxypropyl substitution is about 5%, or about 6%, or about 7%, or about 8%, or about 9%, or about 10%, or about 11%, or about 12%, or about 13%, or about 14%, or about 15%.

The HP starch may also be crosslinked so that in certain embodiments, the α-amylase hydrolyzate is the hydrolysis product of a crosslinked-HP starch.

It is preferable that the hydrolyzate be soluble to aid in its incorporation into food or beverage products and to be an effective enzyme inhibitor. In general, increasing the amount of crosslinking decreases solubility. In certain embodiments, the amount of crosslinking is at least about 1%. In certain embodiments, the amount of crosslinking is less than about 6%, less than about 5%, less than about 4%, less than about 3.5%, or less than about 3%. In certain embodiments, the amount of crosslinking is between about 1% and about 6%. In certain embodiments, the amount of crosslinking is between about 1% and about 5%. In certain embodiments, the amount of crosslinking is between about 1% and about 4%. In certain embodiments, the amount of crosslinking is between about 1% and about 3%. In certain embodiments, the amount of crosslinking is between about 2% and about 6%. In certain embodiments, the amount of crosslinking is between about 2% and about 5%. In certain embodiments, the amount of crosslinking is between about 2% and about 4%. In certain embodiments, the amount of crosslinking is between about 2% and about 3%. In certain embodiments, the amount of crosslinking is between about 3% and about 6%. In certain embodiments, the amount of crosslinking is between about 3% and about 5%. In certain embodiments, the amount of crosslinking is between about 3% and about 4%. In certain embodiments, the amount of crosslinking is about 0.5%, about 1%, about 1.5%, about 2%, about 2.5%, about 3%, or about 3.5%.

C. Alcohol Substitution

Modified starches produced by methods of hydroxypropyl substitution in alcohol can be highly substituted. For example, levels of at least 25% substitution have been achieved. U.S. Pat. No. 4,452,978 discloses methods of preparing HP starches by reacting starch with propylene oxide in a liquid medium comprised of a C1-C3 alkanol and water under alkaline conditions at reaction temperatures in excess of about 100° C., and with reaction times ranging from less than about 1 minute to about 1 hour. Thus, in certain embodiments, an HP starch is substituted in alcohol by reacting starch with propylene oxide in a liquid medium comprised of a C₁-C₃ alkanol and water under alkaline conditions at reaction temperatures in excess of about 100° C. In certain embodiments, the reaction times ranges from less than about 1 minute to about 1 hour.

The first step for preparing the modified starch according to this method is the preparation of a reaction slurry containing the starch starting material, an alkaline agent, and propylene oxide in a liquid medium comprising a C₁-C₃ alkanol and water, preferably less than 10% water by weight of the medium including the water in the starch. The reaction slurry is heated to a temperature of about 145° C. to about 175° C., under autogenic pressure for a period of time ranging from about 1 minute to about 1 hour. The heating process can be conducted in a sealed vessel (batch process) or by passing the reaction slurry through a heated confined zone at a rate calculated to give the required residence time for the slurry in the heated zone (continuous or semi-continuous process).

In certain embodiments, the reaction slurring is prepared by (1) suspending the starch starting material in about 1 to about 3 parts by weight C₁-C₃ alcohol; (2) optionally sparging the alcoholic starch slurry with nitrogen to remove or minimize the amount of dissolve oxygen in the slurry; (3) adding an alkali metal hydroxide (preferably sodium hydroxide or potassium hydroxide or an equivalent thereof) either as pellets or flakes or in concentrated aqueous or alcoholic solution; and (4) adding propylene oxide in an amount sufficient to give the desired hydroxypropyl substitution levels in the starch product.

The alcohol which serves as the major component of the reaction slurry can be methanol, ethanol, propanol, or isopropanol. In certain embodiments, ethanol is preferred. Some proportion of water is also desirable in the reaction slurry. The amount of water in the slurry, however, must be below that which would cause gelatinization of the hydroxypropylated product starch under the reaction conditions of the process. The maximum amount of water which should be added to the reaction mixture depends primarily on the substitution level of the HP starch, the temperature at which hydroxypropylation reaction is conducted, the moisture level of the starch starting material, the form in which the alkaline catalyst is added (that is pellets or flakes opposed to concentrated aqueous solution) and to some extent the alcohol used as the processing medium. Generally where the HP starch will have a level of substitution such that the starch will have a pasting temperature below about 60° C., the reaction slurry should contain less than about 10% by weight water including the water in the starch. Where the granular starch starting material has a water content between about 8 and about 12% by weight, and where the alkaline reagent is added as an aqueous solution, additional water need not be added to the reaction slurry. Applicant has found that the present process is most efficient at the preferred reaction temperatures where the total water content, including the water in the ungelatinized starch starting material, is within a range of about 2 to about 5% by weight of the slurry. A water content of less than about 5% by weight of the slurry is particularly preferred, too, where the starch starting material contains phosphate ester cross-linkages which are more labile under the process conditions at the higher water levels.

The reaction slurry is rendered alkaline by the addition of an alkaline reagent which is substantially soluble in the liquid phase of the reaction slurry. Representative alkaline reagents include alkali metal hydroxides, especially sodium hydroxide or potassium hydroxide or equivalents thereof. As mentioned above the alkaline reagent can be added as a solid, such as pellets or flakes, or in concentrated aqueous or alcoholic solution. In certain embodiments, from about 1 to about 3% by weight of the starch (dsb) of the alkaline reagent is added to the reaction slurry. When sodium or potassium hydroxide is used as the alkaline reagent, applicant has found that the present hydroxypropylation reaction is most efficient when the alkali metal hydroxide is added in an amount equal to about 1.5 to about 2.5% of the weight of starch, dsb. In certain embodiments of the hydroxypropylation process, an alkali metal hydroxide is utilized in the reaction slurry at a rate of about 1.8% of weight of the starch, dsb.

In certain embodiments of alcohol substitution, the hydroxypropylating agent is propylene oxide. The amount of propylene oxide used to carry out this process depends primarily on the desired level of hydroxypropylation of the product reduced-pasting-temperature starch and, as the skilled practitioner will recognize, the efficiency of the hydroxypropylation process under the present conditions.

The reaction of the present hydroxypropylation process, that is the ratio of hydroxypropyl in the starch product to that added to the reaction slurry as propylene oxide depends to some degree on the specific reaction conditions employed, especially time, temperature, water content of the slurry, and degree of alkalinity. Under certain conditions hydroxypropylation proceeds at efficiencies ranging from about 40 to about 70% The amount of propylene oxide needed to effect the desired level of hydroxypropylation of the starch starting material can be estimated using the 40 to 70% efficiency figures and thereafter adjusted in accordance with actual efficiencies measured under the specific conditions used for the hydroxypropylation process.

The alcohol substitution process can be conducted at reaction temperatures ranging from about 100° C. to about 180° C. (or about 210° F. to about 360° F.) and preferably at temperatures between about 145° C. and 175° C. (about 290° C. to about 350° F.). Because the reaction temperatures are far in excess of the boiling point of the liquid medium, the process must be conducted in a closed vessel or otherwise under pressure sufficient to keep the medium in the liquid state at the reaction temperatures.

The time required to complete the present process depends on process parameters such as the reaction temperature, starch concentration, time, the amount of propylene oxide in the reaction mixture, and the desired level of hydroxypropylation of the reduced-pasting-temperature-granular starch product. The reaction time can range anywhere from less than 1 minute up to about 1 hour. In certain embodiments within a temperature range of about 145° C. to about 175° C., reaction time can range from under 5 minutes to about 30 minutes.

While the starch products can be left in the alkaline state, in certain embodiments, they are neutralized with acid. After the heating step the starch slurry is usually cooled to below about 150° F., and then treated with a neutralizing amount of an acid, for example, glacial acetic acid. Enough acid should be added to the reaction mixture so that a 50-ml aliquot of the slurry in a 150-ml of distilled water at room temperature will have a pH of about 4.5-5. Because diffusion of alkali from the processed starch granules into the alcohol medium is slow, the reaction slurry is typically stirred following addition of the acid for a period of about 15 minutes to about 60 minutes. The time required to complete the starch neutralization process can be minimized by warming the neutralizing reaction medium.

The reduced-pasting-temperature granular starch product is separated from the liquid medium component of the reaction slurry by filtration or centrifugation, washed with one or more volumes of the alcohol used in the process (or a mixture of that alcohol and water) and then dried or desolventized by conventional methods. In certain embodiments, the starch is dried in an oven to a certain volatiles level and then contacted with a hot humid gas, preferably moist air, while the starch is maintained at a temperature from about 140° F. to about 250° F.

D. Alpha-Amylase Hydrolyzate

One of skill in the art will understand that the term “α-amylase” refers to an enzymatic activity that randomly hydrolyzes α-(1-4)-glycosidic linkages of starches. Therefore, the invention is defined by α-amylase activity, but is not limited to any particular α-amylase enzyme(s). In certain embodiments, the enzyme that provides the α-amylase activity is food grade.

Some portion of hydroxypropyl substituted starches cannot be digested by digestive enzymes and is considered a chemically modified resistant starch that is defined as a functional fiber. In general, the higher the substitution level, the higher the fiber content in the substituted starch as determined by the AOAC method 2009.01. For example, a certain waxy corn starch with 5.33% HP substitution was determined to have a 31.3% fiber content while a different waxy corn starch with 8.8% HP substitution was determined to have a 53.1% fiber content. In certain embodiments, the hydroxypropyl substituted starch contains at least about 20% fiber before hydrolysis (according to AOAC method 2009.01). In certain embodiments, the hydroxypropyl substituted starch contains at least about 30% fiber before hydrolysis (according to AOAC method 2009.01). In certain embodiments, the hydroxypropyl substituted starch contains at least about 40% fiber before hydrolysis (according to AOAC method 2009.01). In certain embodiments, the hydroxypropyl substituted starch contains at least about 50% fiber before hydrolysis (according to AOAC method 2009.01). Because of this high fiber composition, a significant amount is resistant to digestion in in vitro digestion assays after hydrolysis. For example, for a hydroxypropyl substituted starch containing about 58% fiber before hydrolysis (according to AOAC method 2009.01), about 75% was not digested in a 3 hr in vitro digestion after hydrolysis (Example 2). Analysis revealed that the hydrolyzate products that are not digested in the in vitro digestion inhibit digestive enzymes and slow down digestion of rapidly digestible starch.

Alpha-amylase HP starch hydrolyzates and products after in vitro digestion were characterized by high performance liquid chromatography (HPLC), high performance anion-exchange chromatography with pulsed amperometric detection (HPAE-PAD), and liquid chromatography-mass spectrometry (LC-MS) method.

Hydrolysis products of HP starches have been used as low calorie sugar substitutes and bulking agents. These applications require extensive hydrolysis of HP starches. For example, U.S. Pat. No. 3,505,110 describes the use of a hydrolysis product produced by an enzyme-enzyme procedure (i.e., first treating the starch with a liquefying enzyme and then with a saccharifying enzyme) or by a combination of acid-conversion followed by enzyme saccharification. U.S. Pat. No. 5,110,612 describes treating a hydroxypropylated starch by acid hydrolysis, either alone or in conjunction with enzyme hydrolysis. In the present invention such extensive hydrolysis of the HP starch is not necessary. Further, amyloglucosidase hydrolysis increases the glucose content of the hydrolyzate, making the hydrolyzate less soluble and less effective as a digestive enzyme inhibitor. HP starch hydrolyzed by both amyloglucosidase and α-amylase is less effective than HP starch hydrolyzed by only α-amylase (Example 2). Acid hydrolysis may increase the caloric value and is not required.

The digestive enzyme inhibitor of the invention is prepared by hydrolysis of an HP starch by α-amylase. Extensive digestion of the HP starch such as by a combination of α-amylase hydrolysis and other treatments (e.g., digestion with additional enzymes, acid thinning, shearing) will reduce or eliminate the effectiveness of the hydrolyzate as an inhibitor. In certain embodiments, hydrolysis with α-amylase is not combined with significant amounts of digestion with other enzymes or with acid hydrolysis. In certain embodiments, hydrolysis with α-amylase is not combined with significant amount of physical thinning or shearing. A significant amount of additional digestion, acid hydrolysis, or physical thinning or shearing is an amount that would break the HP starch down more than about what is achieved by α-amylase hydrolysis alone. In certain embodiments, hydrolysis with α-amylase is not combined with digestion with other enzymes or with acid hydrolysis. In certain embodiments, hydrolysis with α-amylase is not combined with physical thinning or shearing.

Various α-amylase enzymes have a wide range of activity, working reaction temperature, reaction time, pH, and other reaction conditions. However, it would be routine for one to determine the conditions necessary for any particular α-amylase enzyme to achieve a given amount of HP starch hydrolysis. For example, in certain embodiments, the viscosity of an HP starch digested with an α-amylase is reduced by at least 10% as measure with a viscometer. Further, it would be routine as described herein to test any such hydrolysis products for inhibition of digestion enzymes such as at least inhibition of glucoamylase digestion.

Hydrolyzates of starches can be characterized by a dextrose equivalent (DE) value. DE is used to indicate the degree of hydrolysis of starch into glucose syrup. DE represents the percentage of the total solids that have been converted to reducing sugars—i.e., the higher the DE, the more sugars and less dextrins present. For example, U.S. Pat. No. 5,110,612 discloses a method of treating hydroxypropylated starch by acid hydrolysis, either alone or in conjunction with enzyme hydrolysis, to produce a hydrolyzed product characterized by a DE value from about 20% to about 45%. As noted, such extensive hydrolysis of the HP starch is not necessary and may decrease or eliminate the effectiveness of the hydrolyzate as a digestive enzyme inhibitor. In certain embodiments, the DE value of the hydrolyzate of HP starch is less than about 15%. In certain embodiments, the DE value of the hydrolyzate of HP starch is less than about 14%. In certain embodiments, the DE value of the hydrolyzate of HP starch is less than about 13%. In certain embodiments, the DE value of the hydrolyzate of HP starch is less than about 12%. In certain embodiments, the DE value of the hydrolyzate of HP starch is less than about 11%. In certain embodiments, the DE value of the hydrolyzate of HP starch is from about 5% to about 15%. In certain embodiments, the DE value of the hydrolyzate of HP starch is from about 5% to about 10%. In certain embodiments, the DE value of the hydrolyzate of HP starch is from about 10% to about 15%.

Hydrolyzates of starch can be characterized by their saccharide distribution. For example, by determining the saccharide distribution as a percent of total saccharides by high performance liquid chromatography (HPLC) (Example 3). In certain embodiments, the saccharide distribution of an α-amylase HP starch hydrolyzate is from about 28.3% to about 29.5% of the combined amounts of glucose (DP1), DP2, DP3, DP4, DP5, DP6, DP7, and DP8 and from about 70.5% to about 71.7% of DP13+. In certain embodiments, the saccharide distribution of the HP starch hydrolyzate is from about 28% to about 30% of the combined amounts of glucose (DP1), DP2, DP3, DP4, DP5, DP6, DP7, and DP8 and from about 70% to about 72% of DP13+. In certain embodiments, the saccharide distribution of the HP starch hydrolyzate is from about 25% to about 35% of the combined amounts of glucose (DP1), DP2, DP3, DP4, DP5, DP6, DP7, and DP8 and from about 65% to about 75% of DP13+. In certain embodiments, the saccharide distribution of the HP starch hydrolyzate is from about 15% to about 25% of the combined amounts of glucose (DP1), DP2, DP3, DP4, DP5, DP6, DP7, and DP8 and from about 75% to about 85% of DP13+. It is believed that the higher the HP substitution of the original HP starch, the higher the % of DP13+.

The hydrolyzate can be further characterized by description of the smaller components. In certain embodiments, the saccharide distribution comprises from about 2.2% to about 3% glucose (DP1), from about 2.73% to about 3.2% DP2, from about 2.3% to about 2.8% DP3, from about 2.6% to about 3% DP4, from about 7.9% to about 8.8% DP5, about 2.9% DP6, from about 3.3% to about 3.9% DP7, and from about 2.8% to about 3.4% DP8. In certain embodiments, the saccharide distribution comprises from about 2% to about 4% glucose (DP1), from about 2% to about 4% DP2, from about 2% to about 4% DP3, from about 2% to about 4% DP4, from about 6% to about 10% DP5, from about 2% to about 4% DP6, from about 3% to about 5% DP7, from about 2% to about 4% DP8.

### IV. Digestive Enzyme Inhibitor and Rapidly Digestible Starch Compositions

It was discovered that the hydrolyzate of certain HP starches digested with α-amylase can be mixed with a rapidly digestible starch to reduce the rate of digestion of the rapidly digestible starch. Without being bound by theory, it is believed that through inhibition of amyloglucosidase by the hydrolyzate, the initial digestion rate of the starch to glucose is reduced. It is believed that the HP starch hydrolyzates as described herein are suitable for reducing the digestion rate of rapidly digestible starches in a food system. Rapidly digestible starches (RDS) can come in many forms, such as liquid solution or dry powders, and are contained in many food products such as breads, cookies, snacks, etc. Starches are classified as rapidly digestible starches if they are rapidly converted to glucose in the presence of digestive enzymes. In certain embodiments, the rapidly digestible starch is a starch or portions thereof that are digested within twenty minutes of digestion as measured by Englyst et al., 1992 (Englyst, H. N., Kingman, S. M., and Cummings, J. H. (1992) Classification and measurement of nutritionally important starch fractions. European Journal of Clinical Nutrition 46:S33-S50). In certain embodiments, the rapidly digestible starch is a starch or portions thereof that when ingested are digested before the post-prandial blood glucose peak time in vivo. Some factors that contribute to whether a starch is rapidly digestible include good solubility and a structure that is conducive to enzymatic digestion. Representative examples of rapidly digestible starches include but are not limited to cooked or gelatinized starches from corn, wheat, rice, potato, and tapioca, and starches in flours of corn, wheat, rice, potato, and tapioca. Representative examples also include but are not limited to starches that can be converted to cooked or gelatinized starches during food processing. Representative examples also include but are not limited to hydrolyzed starches like maltodextrin and dextrin products. For example, maltodextrin is a rapidly digestible hydrolyzed starch.

The present invention provides for compositions of (i) the hydrolysis products of an α-amylase hydrolyzed HP starch (i.e., digestive enzyme inhibitor) and (ii) a rapidly digestible starch (RDS); i.e., hydrolyzate/RDS compositions. Such compositions are especially useful as food ingredients. A food ingredient would generally not be consumed on its own, but rather incorporated with other ingredients into a final food product as defined herein. However, if desired, food ingredients may be consumed without incorporation into a more complex food product.

The present invention provides for a method of producing a composition of the hydrolysis products of an α-amylase HP starch and a rapidly digestible starch (RDS), such as a food ingredient composition. The method comprises combining the hydrolysis products of an α-amylase hydrolyzed hydroxypropyl substituted starch with a rapidly digestible starch. The two components may be combined by mixing together by any of various known methods from small to industrial scales such as by hand mixing to using industrial mixing equipment. In certain embodiments the components are mixed to thoroughly incorporate them together in a homogeneous or near homogenous mixture. If the composition is to be further incorporated with additional ingredients, extensive mixing of the hydrolysis products and rapidly digestible starch together before the addition of other ingredients may not be necessary as the mixing associated with incorporating additional ingredients will also serve to further mix the hydrolysis products and rapidly digestible starch.

In certain embodiments, the hydrolysis product and rapidly digestible starch may be packaged into a package containing the hydrolysis product of an α-amylase digested starch and a rapidly digestible starch.

In certain embodiments, the hydrolyzate is combined with the rapidly digestible starch as a liquid, such as the liquid enzyme reaction immediately following α-amylase hydrolysis. In certain other embodiments, the hydrolyzate is combined with the rapidly digestible starch as a dry product, such as obtained by drying the liquid enzyme reaction following hydrolysis (e.g., Example 2). One of skill in the art will recognize that some amount of drying of the hydrolyzate may result in a product that may be drier than a liquid, but not completely dried, such as a paste, syrup, slurry, or other viscous product, and that any such product is also suitable for combination with the rapidly digestible starch. The rapidly digestible starch may also be dry or contain some amount of moisture or be in a liquid solution. The ratio of the amount of hydrolyzate to the amount of rapidly digestible starch as defined herein is on a dry solids basis. That is, moisture is subtracted from both the hydrolyzate and the rapidly digestible starch when determining the ratio.

In certain embodiments, the ratio of HP starch hydrolyzate to RDS by weight on a dry solids basis may vary from about 20% to about 80% of hydrolyzate to from about 80% to about 20% of RDS. In certain embodiments, the ratio of hydrolyzate to RDS by weight on a dry solids basis may be about 20% of hydrolyzate to about 80% of RDS. In certain embodiments, the ratio of hydrolyzate to RDS by weight on a dry solids basis may be about 30% of hydrolyzate to about 70% of RDS. In certain embodiments, the ratio of hydrolyzate to RDS by weight on a dry solids basis may be about 40% of hydrolyzate to about 60% of RDS. In certain embodiments, the ratio of hydrolyzate to RDS by weight on a dry solids basis may be about 50% of hydrolyzate to about 50% of RDS. In certain embodiments, the ratio of hydrolyzate to RDS by weight on a dry solids basis may be about 60% of hydrolyzate to about 40% of RDS. In certain embodiments, the ratio of hydrolyzate to RDS by weight on a dry solids basis may be about 70% of hydrolyzate to about 30% of RDS. In certain embodiments, the ratio of hydrolyzate to RDS by weight on a dry solids basis may be about 80% of hydrolyzate to about 20% of RDS. It is believed that the higher the amount of hydroxypropyl substitution of the α-amylase-hydrolyzed HP starch, the smaller the ratio of hydrolyzate to rapidly digestible starch would be required to achieve the same level of inhibition of digestion of the rapidly digestible starch.

### V. Food Products

The α-amylase hydrolyzed HP starch of the present invention has a much lower viscosity than non-hydrolyzed HP starch and is thus easier to incorporate into beverages and food products. Further, the product is water soluble and heat stable, which makes it suitable for use in a wide range of food products containing rapidly digestible starches. Representative, non-limiting examples of food products containing rapidly digestible starches in which the hydrolyzate of the invention is contemplated for use include cereal grains, pasta, breakfast cereals, baked goods, dairy products, soups, sauces, gravies, snack foods, nutrition bars, syrup, yogurt, and baby foods. Representative, non-limiting examples of beverage food products include sports drinks, soft drinks, pediatric beverages, flavored waters, smoothies, yogurt drinks, and juices as well as powders, concentrates, etc., used to produce any beverage.

The amount of α-amylase HP starch hydrolyzate added to a food product can be described as a ratio by weight on a dry solids basis of the total amount of rapidly digestible starch (RDS) in the food or beverage. This ratio can be independent of the total weight of the food product. In certain embodiments, the ratio of hydrolyzate to RDS by weight on a dry solids basis is from about 20% to about 80% of hydrolyzate to from about 80% to about 20% of RDS in the food product. In certain embodiments, the ratio of hydrolyzate to RDS by weight on a dry solids basis may be about 20% of hydrolyzate to about 80% of RDS in the food product. In certain embodiments, the ratio of hydrolyzate to RDS by weight on a dry solids basis may be about 30% of hydrolyzate to about 70% of RDS in the food product. In certain embodiments, the ratio of hydrolyzate to RDS by weight on a dry solids basis may be about 40% of hydrolyzate to about 60% of RDS in the food product. In certain embodiments, the ratio of hydrolyzate to RDS by weight on a dry solids basis may be about 50% of hydrolyzate to about 50% of RDS in the food product. In certain embodiments, the ratio of hydrolyzate to RDS by weight on a dry solids basis may be about 60% of hydrolyzate to about 40% of RDS in the food product. In certain embodiments, the ratio of hydrolyzate to RDS by weight on a dry solids basis may be about 70% of hydrolyzate to about 30% of RDS in the food product. In certain embodiments, the ratio of hydrolyzate to RDS by weight on a dry solids basis may be about 80% of hydrolyzate to about 20% of RDS in the food product.

For example, in certain embodiments, if the total amount of RDS in a food product is 80 g, then at least 20 g of hydrolyzate is added to the food product regardless of the total weight of the food product. The hydrolyzate and RDS may be added during production of the food product as an ingredient composition of hydrolyzate and RDS that is pre-combined at least to some extent before addition. For example, an ingredient composition of hydrolyzate and RDS that has a pre-measured ratio of hydrolyzate to RDS may be incorporated into other ingredients to produce a food product. The hydrolyzate and RDS may also be added as separate ingredients to achieve a certain ratio in the food product.

### VI. Method of Controlling Postprandial Glucose

The present invention provides methods of inhibiting at least the main glucose generation enzyme, glucoamylase, in the small intestine of a mammal including human and non-human mammals using the hydrolysis products of certain α-amylase hydrolyzed hydroxypropyl substituted starches. Reduction of the digestion rate of rapidly digestible starches reduces postprandial glucose levels and gives sustained release of glucose over a longer period of time.

Postprandial glucose is controlled by administering to a mammalian subject: (i) the hydrolysis products of an α-amylase hydrolyzed hydroxypropyl substituted starch and (ii) a rapidly digestible starch. In certain embodiments, the hydrolysis products of an α-amylase hydrolyzed hydroxypropyl substituted starch and rapidly digestible starch are administered as ingredients in the same food product.

The hydrolysis products and rapidly digestible starch need not be administered as ingredients in the same food product however. They may be consumed separately, for example, as a food containing a rapidly digestible starch and a beverage containing the hydrolysis products, as one food containing a rapidly digestible and a second food containing the hydrolysis products, as a food containing hydrolysis products and a beverage containing rapidly digestible starch, etc. Preferably they should be administered close in time together, such as within thirty minutes of each other, or within twenty minutes of each other, or within ten minutes of each other, or within five minutes of each other. In certain embodiments, the hydrolysis products and rapidly digestible starch are administered together, even if not as part of the same food product.

### VII. EXAMPLES

The following disclosed embodiments are merely representative of the invention which may be embodied in various forms. Thus, specific structural, functional, and procedural details disclosed in the following examples are not to be interpreted as limiting.

### Example 1

Acarbose, a known and effective inhibitor of glucoamylase, was used as a control to quantify the inhibition of glucoamylase by MIRA-SPERSE 2000° (available from Tate & Lyle Ingredients Americas, Inc., Decatur, Ill.)—a waxy cross-linked HP starch with about 10% HP substitution and about 2% cross-linking. It was determined that MIRA-SPERSE 2000® was about 150 to about 200 times less effective than acarbose as an inhibitor of glucoamylase.

It was determined that MIRA-SPERSE 2000® is partially hydrolyzed by pancreatin and the components of the hydrolyzate inhibit glucoamylase. To validate this observation, MIRA-SPERSE 2000 was pre-hydrolyzed by various α-amylases, such as TERMAMYL° and GC 358, and the products were tested by in vitro assay for sustained release of glucose using a maltodextrin (STAR-DRI® 1015; available from Tate & Lyle Ingredients Americas, Inc., Decatur, Ill.) as the substrate. All of the hydrolysis components showed similar profiles for glucose release.

### Experimental Methods

Preparation of Enzyme Solution:

1. 0.5 g of pancreatin (Porcine pancreas, EC No 232-468-9, Sigma P2545 (St. Louis, Mo.)) was added to 60 mL of de-ionized water and stirred for 10 minutes.

2. The enzyme solution was then centrifuged in a centrifuge tube at 3000 rpm for 10 minutes.

3. The enzyme solution was 4 mL pancreatin supernatant plus 1 mL amyloglucosidase (AMG 300 L, Novozymes North America Inc., Franklinton, N.C.) plus 95 mL of de-ionized water.

Sample and Inhibitor Solution Preparation:

1. An 8% solution of a waxy-based agglomerated 10 DE maltodextrin (final d.s. 3.2% in 25 mL digestive solution) was prepared using sodium acetate buffer (0.1 M, pH 5.2, 0.016 M CaCl₂).

2. Shearing—10 g of MIRA-SPERSE 2000® was dissolved in 80 mL of sodium acetate buffer to make a 0.111 g/g solution. The starch was sheared at 10,000 rpm for 5 minutes using an Ultra-Turrax T25 (Janke & Kunkel, IKA Labortechnik, Wilmington, N.C.) and cooked for 5 minutes at boiling temperature.

3. Enzyme hydrolysis—60 g of tap water was heated to 90° C. to which either 0.05 mL of TERMAMYL® (120 Kilo Novo Unit (KNU)/g; density: 1.25 g/mL)(α-amylase available from Novozymes North America, Inc., Franldinton, N.C.) or GC 358 (activity: minimum 13,775 Alpha Amylase Units (AAU)/g; specific gravity: 1.15-1.19 g/mL)(α-amylase available from Danisco U.S., Inc., Genencor Division, Rochester, N.Y.) was added, then 7.5 g of MIRA-SPERSE 2000® was added gradually to make a solution of 0.111 g/g. The mixture was incubated for 30 minutes. The pH was then adjusted to pH 3.5 and the solution was boiled for 10 minutes. The pH was then adjusted to pH 5.2.

4. 20 mg of Acarbose was weighed and dissolved in 2 mL of water to make a 10 mg/mL solution.

TABLE 1
Inhibition test of the sheared MIRA-SPERSE 2000 ®.

| | | 8% maltodextrin | Acarbose | Sheared HP | | Sodium acetate | Enzyme |
|---|---|---|---|---|---|---|---|
| Sample | Inhibitor | buffer | solution | starch solution | | buffer | solution |
| 1 | None | 10 mL | 0 mL | 0 | g | 10 mL | 5 mL |
| 2 | Acarbose | 10 mL | 10 mL | 0 | mL | 10 mL | 5 mL |
| 3 | Acarbose | 10 mL | 5 mL | 0 | mL | 10 mL | 5 mL |
| 4 | HP starch | 10 mL | 0 mL | 5 | g | 5 mL | 5 mL |
| 5 | HP starch | 10 mL | 0 mL | 10 | g | 0 mL | 5 mL |
| 6 | HP starch | 0 mL | 0 mL | 10 | g | 10 mL | 5 mL |

TABLE 2
Inhibition test of enzyme hydrolyzed MIRA-SPERSE 2000 ®.

| | | 8% maltodextrin | Acarbose | | Sodium acetate | Enzyme |
|---|---|---|---|---|---|---|
| Sample | Inhibitor | buffer | solution | | buffer | solution |
| | | | | Termamyl hydrolyzed | | |
| | | | | HP starch solution | | |
| 1 | None | 10 mL | 0 μL | 0 mL | 10 mL | 5 mL |
| 2 | HP starch | 0 mL | 0 μL | 10 mL | 10 mL | 5 mL |
| 3 | HP starch | 10 mL | 0 μL | 10 mL | 0 mL | 5 mL |
| | | | | GC358 hydrolyzed | | |
| | | | | HP starch solution | | |
| 4 | HP starch | 0 mL | 0 μL | 10 mL | 10 mL | 5 mL |
| 5 | HP starch | 10 mL | 0 μL | 10 mL | 0 mL | 5 mL |

Enzyme Digestion:

1. 5 glass balls (5 mm in diameter) were added to test tubes with samples and equilibrated to 37° C. for 10 minutes before 5 mL of the enzyme solution was added.

2. All samples were placed into a 37° C. shaker bath horizontally and shook at 130 rpm.

3. 100 μl, samples were taken at time points: 0, 15, 30, 45, 60, 75, 90, 105, and 120 minutes. Each sample was mixed with 2 mL of 95% aqueous ethanol and vortexed.

Glucose Determination:

The glucose formed in the samples was determined by the Megazyme kit (Wicklow, Ireland).

Megazyme Glucose Oxidase Method:

100 μL water is mixed with 3 mL of GOPOD as blank.

100 μL 1 mg/ml glucose standard is mixed with 3 mL of GOPOD (Chromogen reagent).

100 μL of the enzyme reacted solutions with ethanol, the glucose standard solution, and the blank are mixed with 3 mL of GOPOD.

The solutions are incubated at 50° C. for 20 minutes.

The absorbance (O.D.) at 510 nm was read against the reagent blank.

Calculation: Glucose pg/0.1 mL=(O.D. Sample/O.D. Glucose Standard, 100 μL)×100.

Results and Discussion

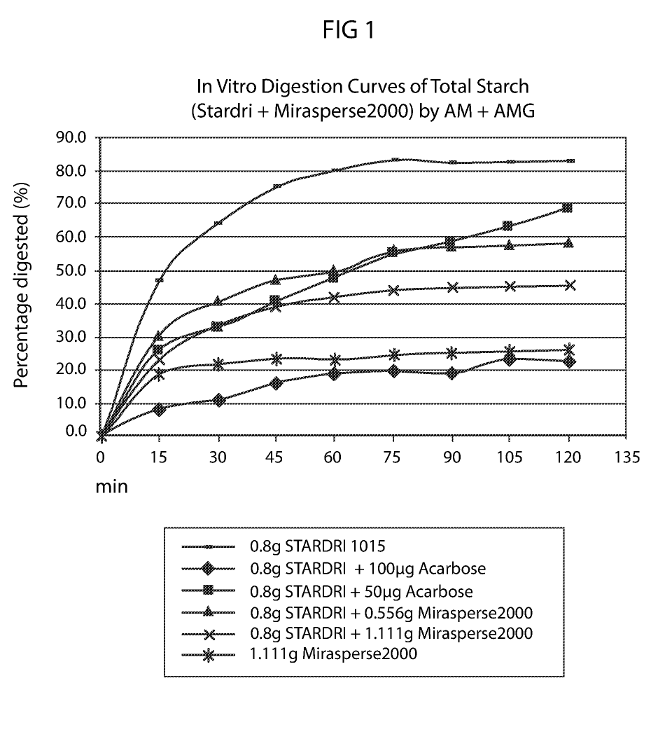

The in vitro digestion rate of the maltodextrin was significantly reduced by addition of 50 and 100 μg of acarbose (0.0063% and 0.0125% of 0.8 g dry solid base) (FIG. 1). Glucose was continuously generated during 2 hours of digestion, which is a typical characteristic of a sustained release carbohydrate (SRC).

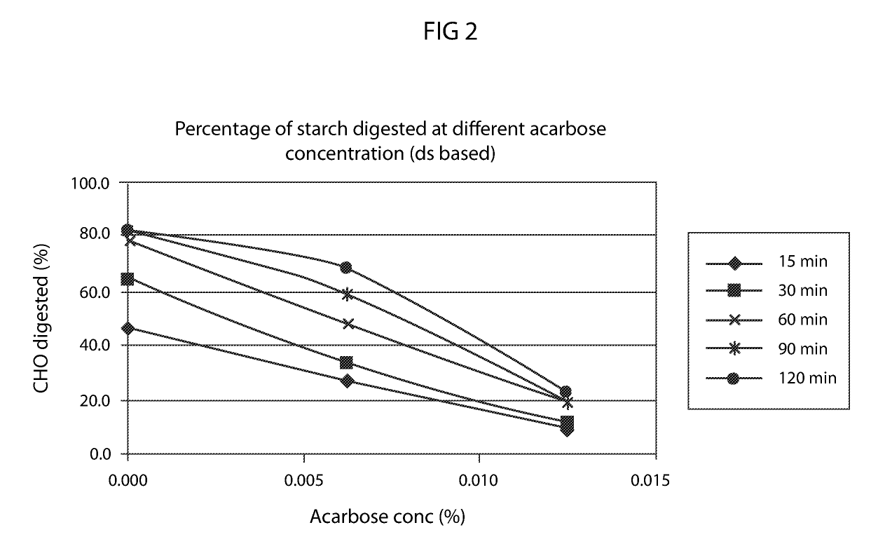

FIG. 2 shows the extent of digestion of the maltodextrin at different concentrations of acarbose. At 30 minutes of digestion, the percentage of maltodextrin digested was predicted to be reduced by 50% (IC₅₀, inhibitor concentration that gives 50% inhibition) with addition of 0.007% acarbose (FIG. 2).

FIG. 1 shows that the hydrolyzate of the cross-linked HP starch also inhibited digestion of the maltodextrin. The digested percentages of mixtures of the maltodextrin and hydrolyzate of cross-linked HP starch were significantly lower than that of the maltodextrin alone on total carbohydrate base (FIG. 1).

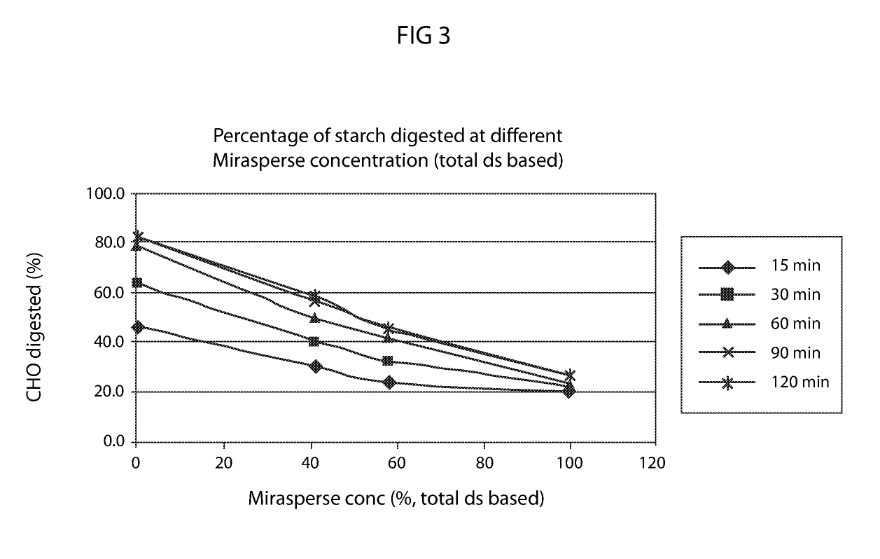

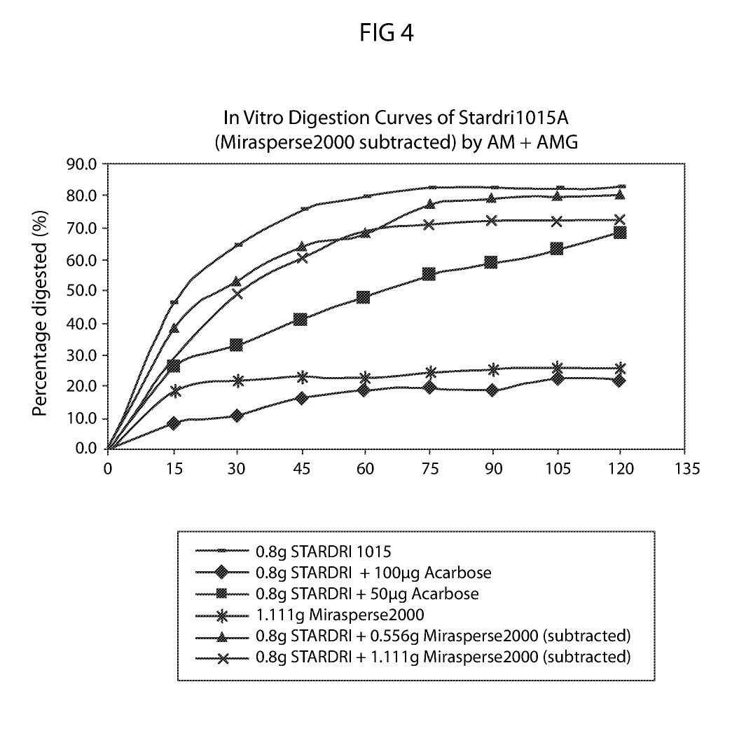

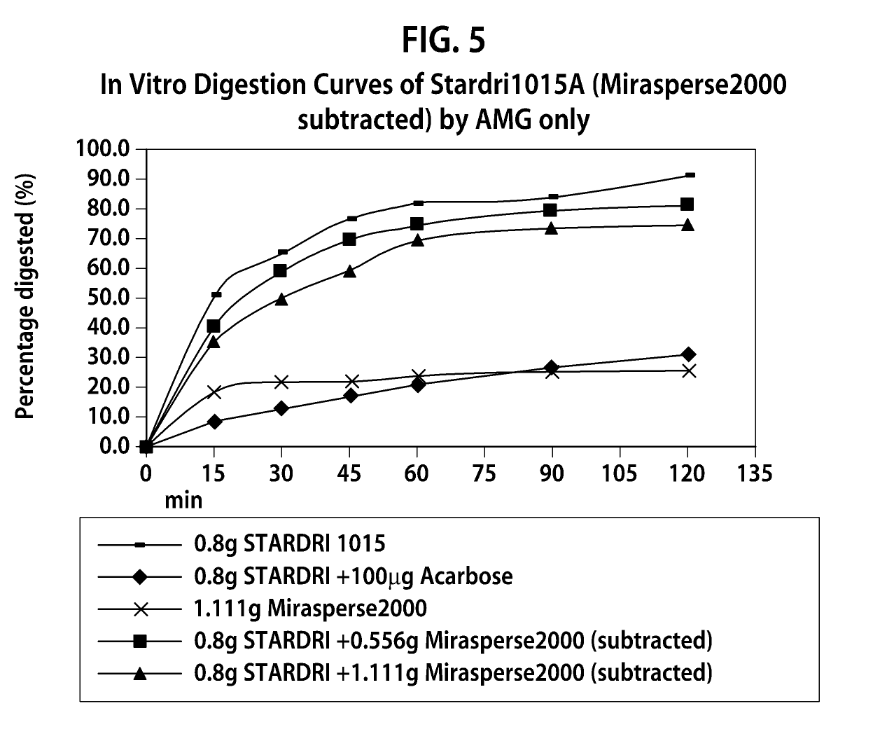

FIG. 3 predicts that the IC₅₀ would be 60% for the hydrolyzate of the cross-linked HP starch at 30 minutes of digestion and 68% at 60 minutes on total carbohydrate base. Addition of the hydrolyzate of the cross-linked HP starch to the maltodextrin was not a simple additive mixture, however. When the glucose generated by the hydrolyzate of the cross-linked HP starch was subtracted, the digestion of the maltodextrin in the mixture was still lower compared to the digestion of the maltodextrin alone (FIG. 4), which indicated that the hydrolyzate of the cross-linked HP starch inhibited the digestive enzymes of amyloglucosidase and/or α-amylase. When only amyloglucosidase was used in the digestion, the reduction of maltodextrin reduction in the mixture was still observed (FIG. 5), which indicated that the hydrolyzate of the cross-linked HP starch inhibited at least amyloglucosidase.

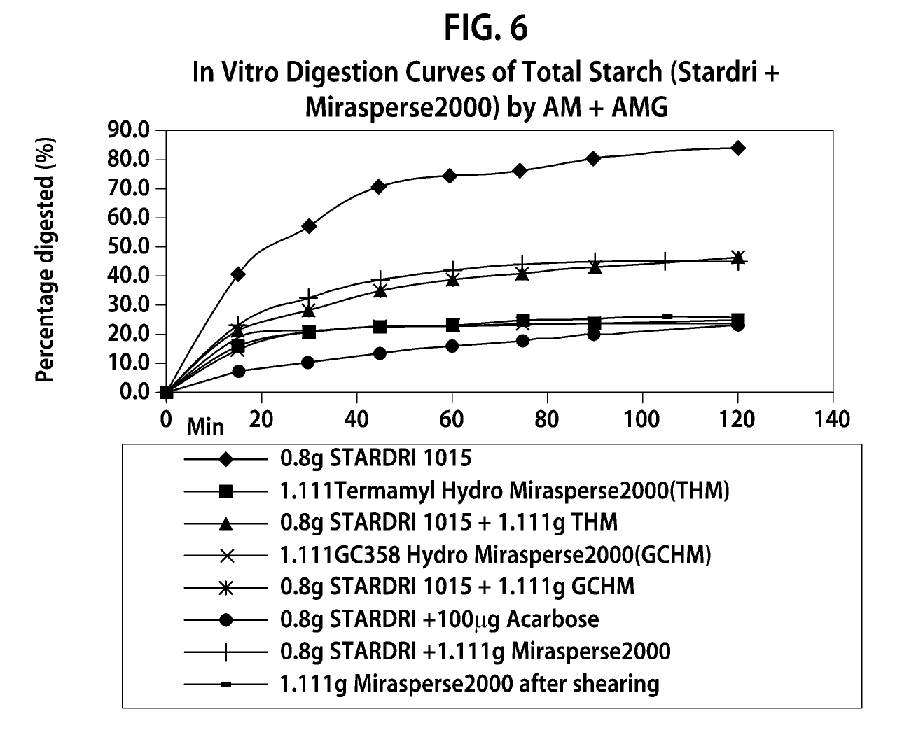

FIG. 6 shows that the cross-linked HP starch hydrolyzed by either TERMAMYL® or GC 358 is similar or slightly more effective than the sheared cross-linked HP starch at inhibiting total carbohydrate digestion.

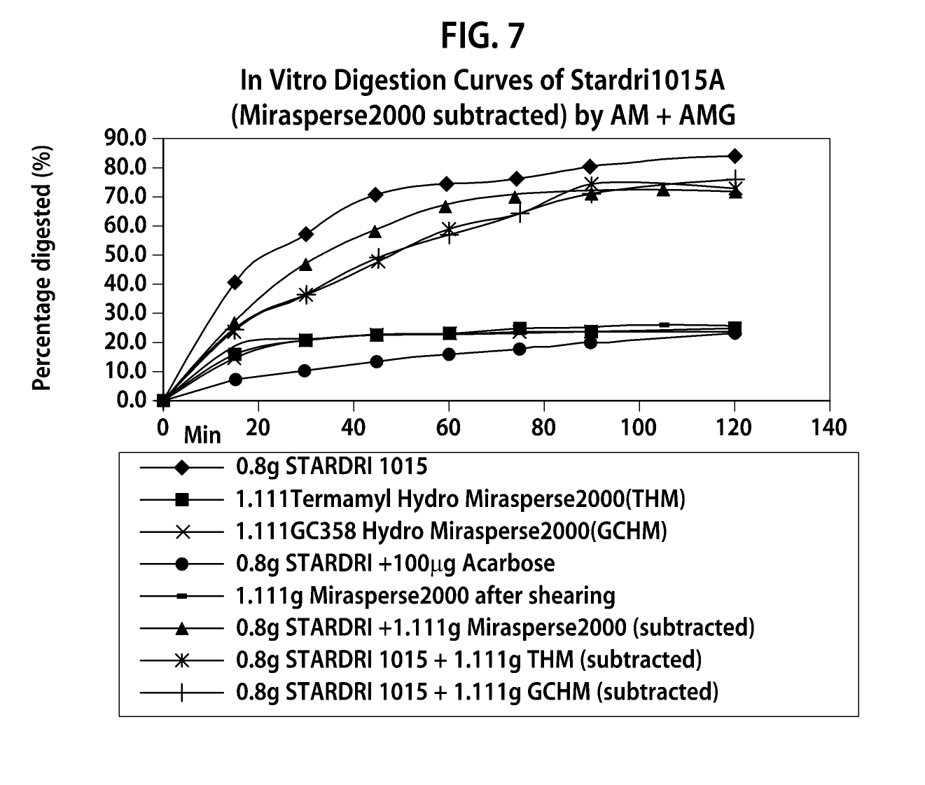

When the glucose generated by the sheared or hydrolyzed cross-linked HP starch was subtracted, the digestion of the maltodextrin in the mixture was lower compared to the digestion of the maltodextrin alone (FIG. 7). The hydrolyzate of the cross-linked HP starch was more effective at inhibiting early digestion (e.g., between about 15 to about 90 minutes) of the maltodextrin (FIG. 7).

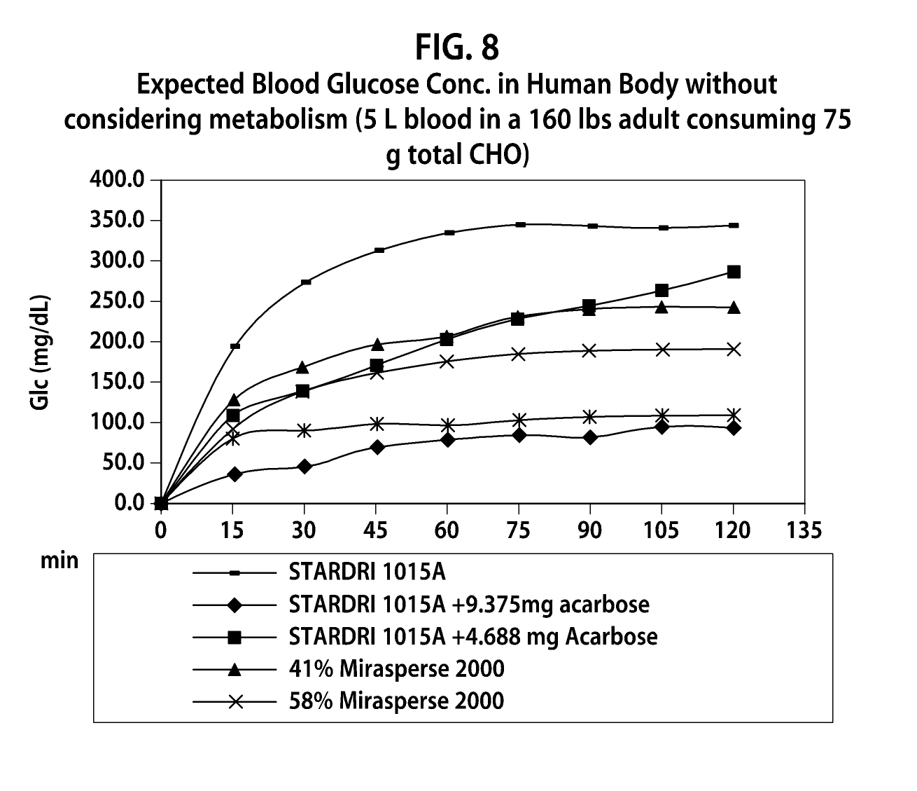

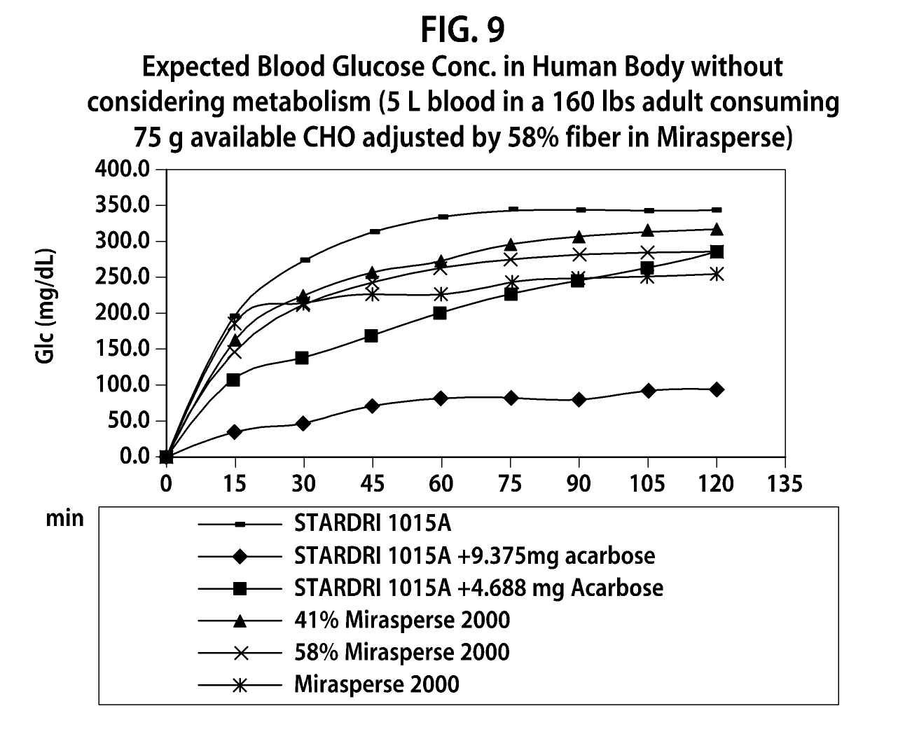

FIG. 8 and FIG. 9 show the hypothetical blood glucose concentrations in a 160 lb adult human with 5 L of blood after consumption of 75 g of total carbohydrate (FIG. 8) or 75 g of available carbohydrate (FIG. 9) of the maltodextrin, the hydrolyzate of the cross-linked HP starch, and a mixture of maltodextrin and hydrolyzate of the cross-linked HP starch, as if there was no metabolism of absorbed glucose. In calculations of available carbohydrate, the maltodextrin was considered 100% available and the hydrolyzate of the cross-linked HP starch was considered to contain 42% of available carbohydrate since the fiber content of the cross-linked HP starch used in this specific example was determined to be 58% by AOAC method 2009.01.

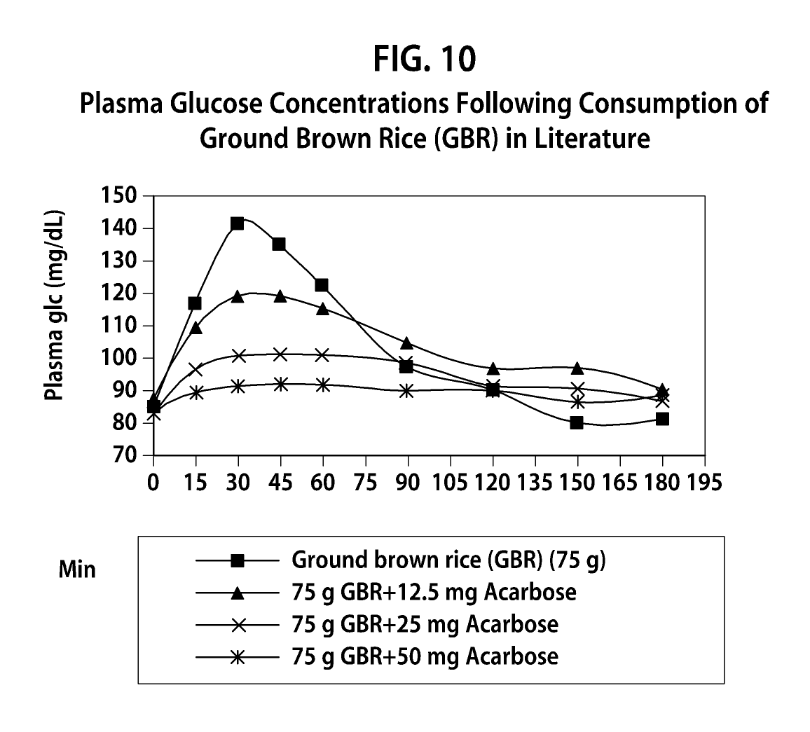

FIG. 10 is a plot of data contained in O'Dea and Turton that shows that acarbose can lower plasma glucose at a dose of 12.5 gm when mixed in 75 g ground brown rice. (O'Dea and Turton, J., The American Journal of Clinical Nutrition 1985; 41(3): 511-16).

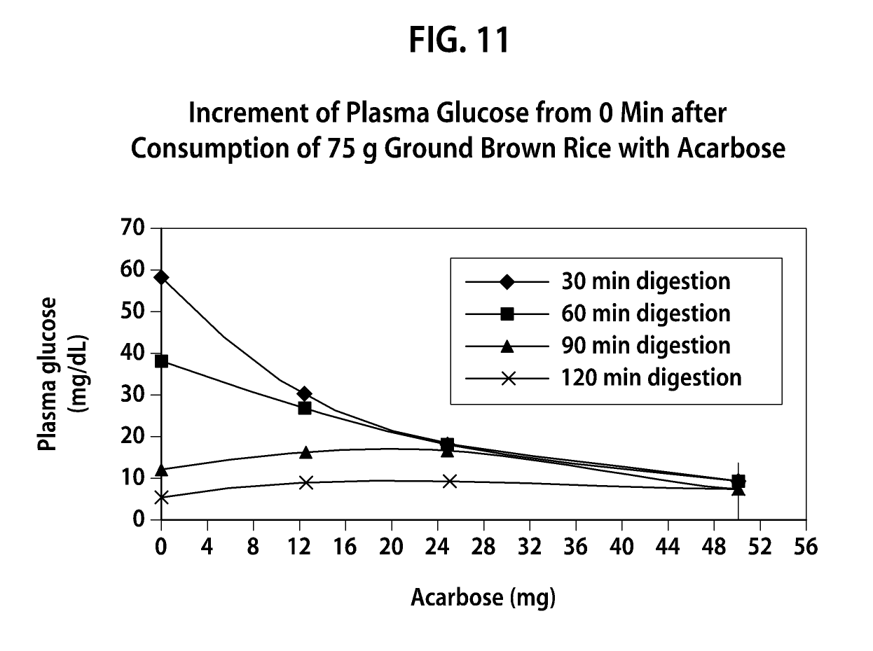

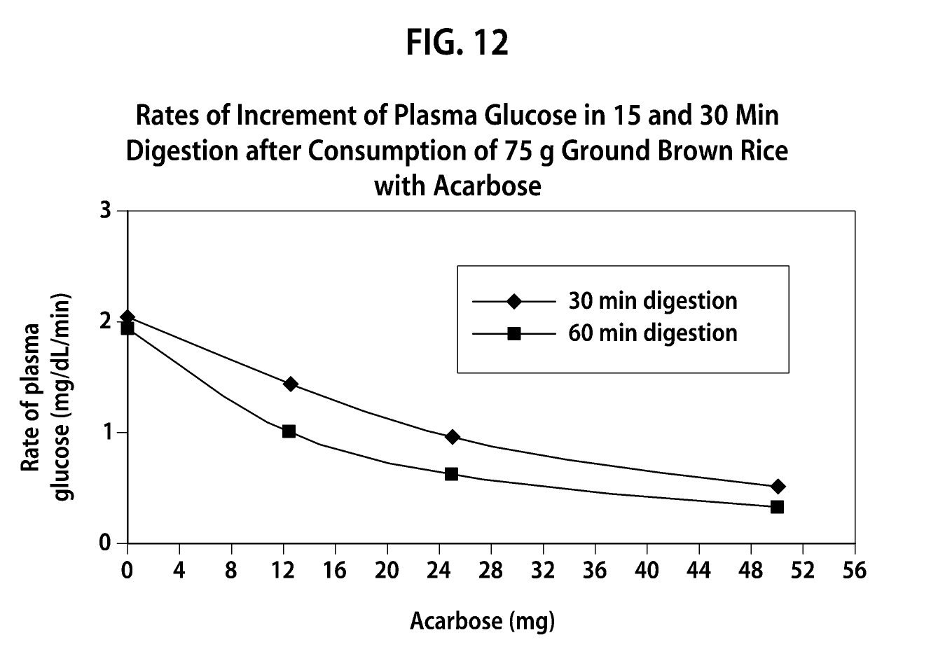

FIG. 11 shows that reduction of plasma glucose is evident at 30 minutes and 60 minutes digestion and less evident at 90 minutes and 120 minutes digestion. The increment of plasma glucose was reduced by 50% with 12.5 mg of acarbose at 30 minutes or with 25 mg of acarbose at 60 minutes (FIG. 11). The rate of plasma glucose increment in the initial 30 minute periods were reduced by 50% with 12.5 mg acarbose (FIG. 12). Acarbose IC₅₀ at 30 minutes of in vitro digestion was 0.007% and the cross-linked HP starch at 30 minutes of in vitro digestion was 60%, so the efficacy of acarbose at 30 minutes digestion in the in vitro assay was 8571 times higher than that of the cross-linked HP starch (Table 3). Since acarbose IC₅₀ is 12.5 mg or 0.0167% (d.s. base) at 30 minutes in vivo digestion, the extrapolated value of the cross-linked HP starch would be about 150% to have the same effect as 12.5 mg (0.0167%) acarbose in vivo (Table 3).

TABLE 3
Efficacy of the hydrolyzate of the
cross-linked HP starch versus acarbose.
Efficacy of the HP Starch vs Acarbose

| | Inhibitor concentration to give 50% inhibition (IC50) | |
|---|---|---|
| | In vitro digestion 30 minutes | In vivo digestion 30 minutes |
| Acarbose | 0.007% | 0.0167% |
| HP Starch | 60% | Extrapolated value = 150% |

### Example 2

Scaled-up procedure for preparing hydrolyzed MIRA-SPERSE 2000® cross-linked HP starch for sustained release carbohydrate.

1. About 5 gallons (18.93 L) of tap water is heated to 90° C.

2. 11.33 lb 92% d.s. of MIRA-SPERSE 2000® (10.425 lb or 4.73 kg d.s. starch) (20% final d.s.) is weighed out.

3. About 0.5 lb of MIRA-SPERSE 2000® is added to the hot tap water while stirring.

4. 31.5 mL of TERMAMYL® α-amylase is then added.

5. The rest of the 10.425 lb of the MIRA-SPERSE 2000® is added gradually.

6. The pH is checked to pH 5.6.

7. The mixture is incubated for 30 minutes at 90° C.

8. The paste pH is adjusted to pH 3.5 using 1 N sulfuric acid.

9. The paste is heated to 95° C. for 20 minutes to inactivate the α-amylase.

10. The paste pH is adjusted to pH 5.2 using 1 N NaOH.

11. The slurry is cooled to less than 60° C. and pumped directly into a Niro spray-dryer using a peristaltic pump. The product is spray dried using a Niro spray-dryer at inlet temperature of 200° C. and outlet temperature of 100° C.

12. Dry product weight is about 3.5 kg.

Comparison of Digestibility and Enzyme Inhibition of TERMAMYL®-Hydrolyzed MIRA-SPERSE 2000® Made in Small Scale and Scaled-Up Production Method Using in Vitro Assay.

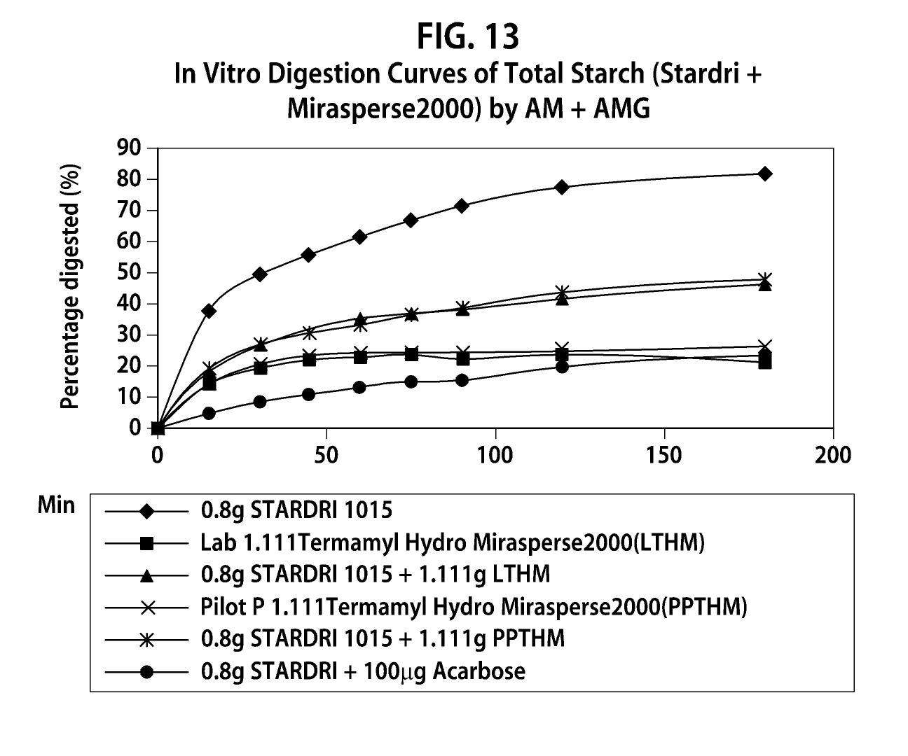

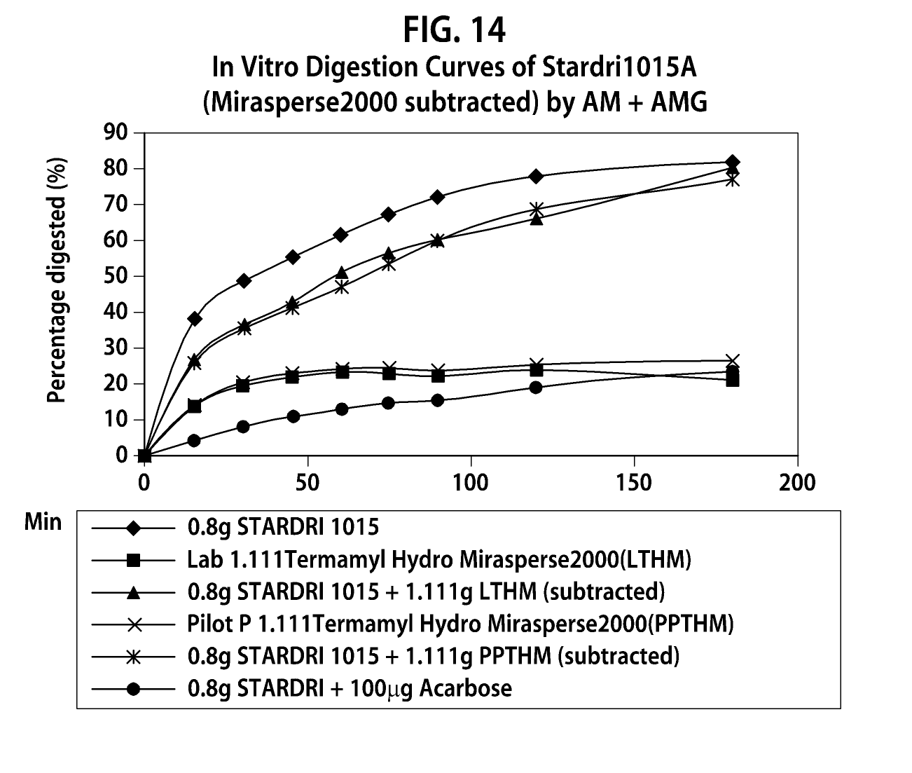

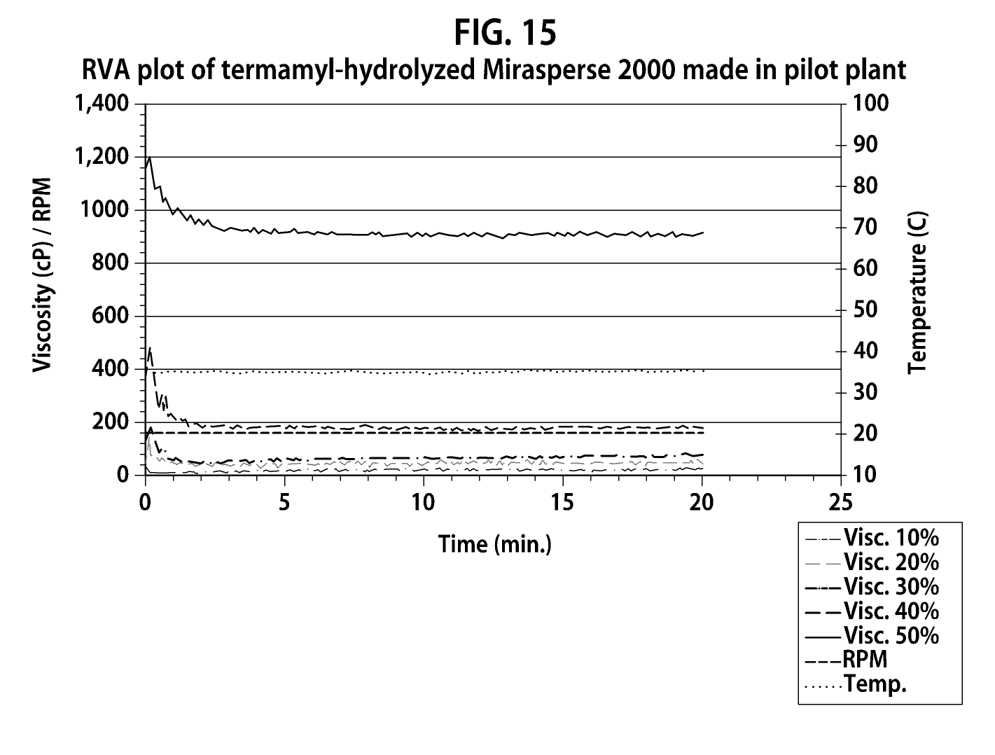

FIG. 13 and FIG. 14 show in vitro digestion results using the same in vitro assay described in Example 1. The digestibility and enzyme inhibition of TERMAMYL®-hydrolyzed MIRA-SPERSE 2000® starch made in small scale (Lab) and with the scaled-up production method (Pilot) are similar, which demonstrates that the process can be scaled-up. The viscosity of TERMAMYL®-hydrolyzed MIRA-SPERSE 2000® made by the scaled-up production method (pilot plant) is shown in FIG. 15.

### Example 3

The hydrolysis products of a waxy cross-linked HP starch (MIRA-SPERSE 2000®) by α-amylase and by in vitro digestion were characterized to understand the inhibition and indigestible molecules. The cross-linked HP starch was hydrolyzed using TERMAMYL® α-amylase as described below. The hydrolyzate inhibited the digestion of a maltodextrin (STAR-DRI® 1015; available from Tate & Lyle Ingredients Americas, Inc., Decatur, Ill.) and a mixture of the hydrolyzate and maltodextrin was characteristic of a sustained release carbohydrate in vitro.

The cross-linked HP starch used in this representative example was determined by NMR to have 9.7% substitution before α-amylase hydrolysis and 9.96% substitution after α-amylase hydrolysis.

Large Scale α-amylase Hydrolysis:

1. About 5 gallons (18.93 L or 417.7 lb) of tap water was heated to 90° C.

2. Weighed out 11.33 lb 92% ds cross-linked HP starch (10.425 lb or 4.73 kg ds starch).

3. About 0.5 lb of the cross-linked HP starch was added to the hot tap water while stirring.

4. 31.5 mL of TERMAMYL® α-amylase was added.

5. The balance of the 10.425 lb of cross-linked HP starch was gradually added.

6. The pH of the 20% final ds solution was checked to ensure pH at 5.6.

7. The mixture was incubated for 30 minutes at 90° C.

8. The pH of the paste was adjusted to pH 3.5 using 1 N sulfuric acid (about 40 mL).

9. The paste was heated to 95° C. for 20 minutes to inactivate the α-amylase.

10. The pH of the paste was adjusted to pH 5.2 using 1 N NaOH (about 40 mL).

11. The slurry was cooled to less than 60° C. and pumped directly into the Niro spray-dryer using a peristaltic pump. The dryer was operated at an inlet temperature of 200° C. and an outlet temperature of 100° C.

12. The dry material was collected from the cyclonic separator on the Niro dryer. The weight of the collected dry product was 3.6 kg.

Small Scale α-amylase Hydrolysis

1. Heat 60 g of tap water to 90° C.

2. Add 0.05 mL of T TERMAMYL® α-amylase.

3. Add 7.5 g of cross-linked HP starch gradually to make a solution of 0.111 g/g.

4. Incubate the mixture for 30 minutes.

5. Adjust the pH to pH 3.5.

6. Boil for 10 minutes.

7. Adjust the pH to pH 5.2.

### In Vitro Digestion

Preparation of Enzyme Solution:

1. Add 0.5 g pancreatin (Porcine pancreas, EC No. 232-468-9, Sigma P2454, (St. Louis, Mo.)) to 60 mL de-ionized water and stir for 10 minutes.

2. Centrifuge enzyme solution in a centrifuge tube at 3000 rpm for 10 minutes.

3. Enzyme solution: 4 mL pancreatin supernatant plus 1 mL amyloglucosidase (AMG 300 L, Novozymes North America; activity: amyloglucosidase units (AGU 300/mL) plus 95 mL of de-ionized water.

Enzyme Digestion:

1. 10 mL α-amylase hydrolyzed cross-linked HP starch was added to 10 mL sodium acetate buffer.

2. 5 glass balls (5 mm diameter) were added and equilibrated to 37° C. for 10 minutes.

3. 5 mL of enzyme solution was added.

4. Samples were placed in a 37° C. shaker bath horizontally and shook at 130 rpm.

5. Hydrolyze for 3 hours.

6. The slurry was boiled for 15 minutes (for GPC DP1-10 analysis).

Glucose Determination:

The glucose formed in the samples was determined by the Megazyme glucose oxidase kit (Megazyme International Ireland Ltd., Wicklow, Ireland).

HPLC Method

High Performance Liquid Chromatography (HPLC) utilizing a resin based column in the silver form to separate sugars of different degrees of polymerization (DP) from one another was used. Aminex carbohydrate columns separate compounds using a combination of size exclusion and ligand exchange mechanisms. In oligosaccharide separations, size exclusion is the primary mechanism. Low cross-linked resins allow carbohydrates to penetrate, and oligosaccharides separate by size. For monosaccharide separations, ligand exchange is the primary mechanism which involves the binding of hydroxyl groups of the sugars with the fixed counter-ion of the resin. Ligand exchange is affected by the nature of the counter-ion (Ag+, Ca++, etc.) and by the spacial orientation of the carbohydrate's hydroxyl groups.

Samples were run using the following conditions (Table 4).

TABLE 4
Instrument Parameters: Water system.

| | |
|---|---|
| 1 | Column: 30 cm L × 7.8 mm I.D. HPX-42A. |
| 2 | Column Temp: 85° C. |
| 3 | Solvent: Deionized degassed water. |
| 4 | Flow Rate: 0.6 mL/min |
| 5 | Detector Sensitivity: 16 X |
| 6 | Injection Volume: 20 μl |
| 7 | Run time: 25 minutes |

The samples were run as prepped, approximately 4% dry solids. A standard containing known straight chain carbohydrates from dextrose to maltohexose (DP6) was prepared and analyzed to compare to retention times of possible substituted carbohydrates.

Gel Permeation Chromatography (GPC) Method

GPC separates molecules based on their size or hydrodynamic volume in solution. Samples are diluted in water and the molecules are separated using four columns of varying pore sizes in series; a Water's Ultrahydragel 120 angstrom column, two 250 angstrom columns and one 1000 angstrom column. The eluent is water with 0.1 N NaNO₄ added; flow rate is 0.6 ml/min.

After separation the molecules are detected with a differential refractive index detector that feeds the raw data to a multichannel chromatographic software package. Molecular weight distributions are calculated based on comparison to a series of polysaccharide molecular weight standards using a narrow polydispersity calibration technique.

High Performance Anion-Exchange Chromatography with Pulsed

### Amperometric Detection (PHPAE-Pad)

Carbohydrates were analyzed by ion chromatography. The carbohydrates were converted into their anionic form and separated on a strong basic anion exchanger in the hydroxide form. The carbohydrate anions are detected by pulsed amperometric detection at a gold working electrode. The separation is achieved with a Dionex Carbopac PA1 column set with gradient elution of acetate in sodium hydroxide. Initial run conditions were 100 mM sodium hydroxide for 4 minutes at 1.2 mL/min. Over the next 20 minutes, sodium acetate was added from 0 to 375 mM concentration and held at the upper concentration for 10 minutes (100 mM NaOh/375 mM NaOAc). Samples and standards were all diluted in water.

### Liquid Chromatography-Mass Spectrometry (LC-MS) Method:

All the samples were filtered using 0.45 micron nylon filter prior to analysis. The MS and LCMS conditions are given in Table 5 and Table 6, respectively.

TABLE 5
MS Conditions.

| Ionization | ESI in Negative Mode | |
|---|---|---|
| Capillary Voltage | 2850 | V |
| Cone Voltage | 10 | V |
| Sample Cone Voltage | 10 | V |
| Source Temperature | 120° | C. |
| Desovation Temperature | 400° | C. |
| Flight Tube | 5630 | |
| MCP Detector | 2300 | |
| Scan Range | 50-1500 | amu |
| Gas Flow | 1 | L/hr |
| Nitrogen Desolvation Gas Flow | 300 | L/hr |
| Reference Cone Voltage | 5 | V |
| Reference Collision Energy | 5 | V |

TABLE 6
LC Conditions.

| Run Type | Isocratic |
|---|---|
| Mobile Phase A | Water (92%) |
| Mobile Phase B | Acetonitrile (8%) |
| Column Type | BioRADAminex HP |
| | Carbohydrate 300 mm × 7.8 mm |
| Column Temperature | 85° C. |
| Injection Volume | 30 μL |
| Flow Rate | 0.6 mL/mine |

### Analysis

The waxy cross-linked HP starch of this example was determined by NMR to have a hydroxypropyl substitution of 9.7% or 0.23 molar substitutions (MS). After α-amylase digestion, the hydroxypropyl substitution was 9.96%. The samples were analyzed by liquid chromatography (LC) and anion exchange chromatography, and labeled:

271266: Small-scale α-amylase hydrolyzed cross-linked HP starch (4.44% dry solids or ds)

271267: Large-scale α-amylase hydrolyzed cross-linked HP starch (4.44% ds)

271268: Sample 271266 after in vitro digestion (4.44% ds)

271269: Sample 271267 after in vitro digestion (4.44% ds)

270721: Same sample as 271267 (5% ds)

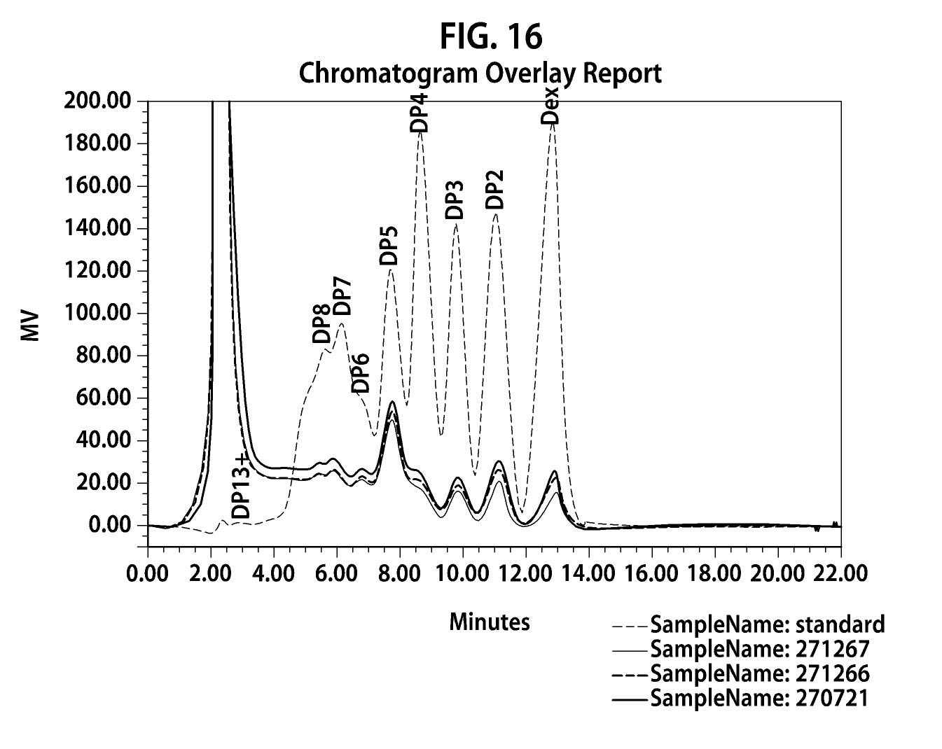

FIG. 16 shows a HPLC chromatogram of α-amylase hydrolyzed MIRA-SPERSE 2000® using HPLC with Aminex silver-form column. Glucose, DP2, DP3, DP4, DP5, DP6, DP7, DP8, DP9 and DP13+ were separated and their percentages are reported in Table 7. The amounts of DP13+ and DP5 were approximately 70% and 8% respectively and the rest were in the range of 2-5%.

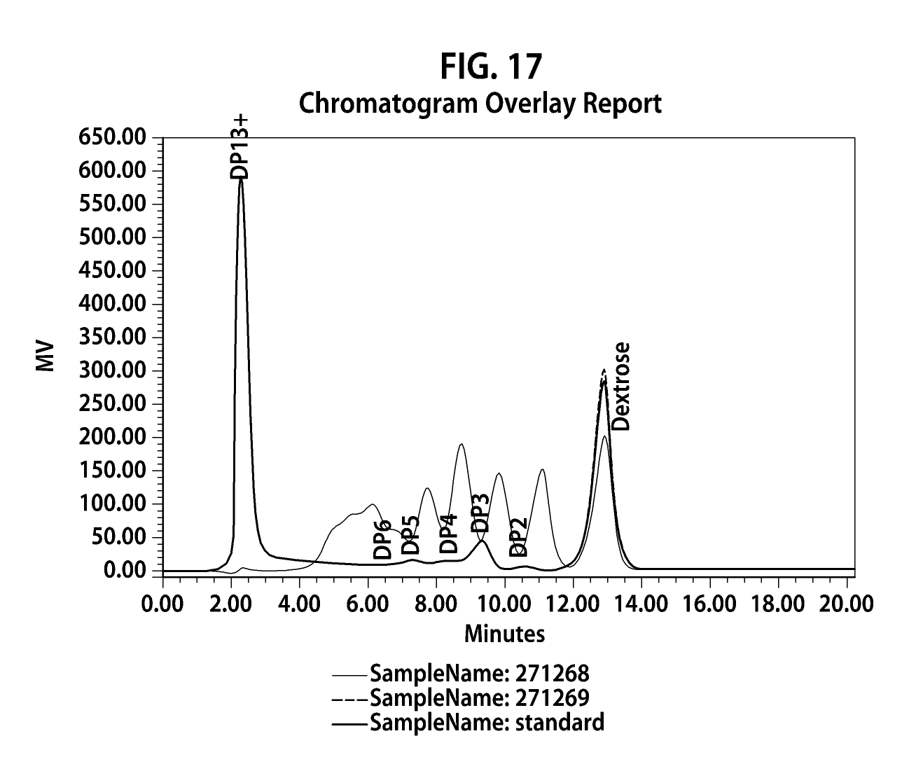

FIG. 17 shows a chromatogram of the α-amylase hydrolyzed cross-linked HP starch after in vitro digestion. The glucose peak increased significantly while the other peaks decreased after in vitro digestion by pancreatic α-amylase and amyloglucosidase. Peak position were shifted to higher molecular weight direction from the standards, indicating HP substitution. The percentages of saccharides are reported in Table 7. The peak between standard DP3 and DP4 could be HP substituted maltotriose. In a paper by Leegwater and Speek (1972), several HP oligoglucoses were detected in the feces of rats on diets containing hydroxypropyl starches with MS varying from 0.025-0.106. The major components were tentatively identified as HP substituted maltose, di-HP maltotriose, and di-HP maltotetraose. There was a tendency reported that peaks of di-HP maltotriose and di-HP maltotetraose increased with increase of MS. In the present example, the MS of the waxy cross-linked HP starch was more than double the highest MS of the samples reported in the literature. Thus, it is reasonably believed that the peak between the standards of DP3 and DP4 is dihydroxypropylmaltotriose.

TABLE 7
Saccharide distributions of hydrolyzed cross-linked HP starch (% of total).

| Sample | DP1 | DP2 | DP3 | DP4 | DP5 | DP6 | DP7 | DP8 | DP9 | DP13+ |
|---|---|---|---|---|---|---|---|---|---|---|
| 270721 | 3.15 | 3.43 | 2.78 | 3.08 | 8.08 | 2.54 | 1.64 | 2.24 | 2.71 | 70.36 |
| 271266 | 2.24 | 2.73 | 2.29 | 2.61 | 8.84 | 2.88 | 3.94 | 2.77 | → | 71.69 |
| 271267 | 3.02 | 3.19 | 2.75 | 3.02 | 7.91 | 2.91 | 3.27 | 3.41 | → | 70.52 |
| 271268 | 34 | 0.7 | 5.75 | 2.42 | 2.4 | 1.39 | → | → | → | 53.38 |
| 271269 | 34.7 | 0.65 | 6.01 | 2.11 | 2.32 | 1.53 | → | → | → | 52.72 |

The glucose contents of the α-amylase hydrolyzed cross-linked HP starch before and after in vitro digestion are shown in Table 8. The glucose contents before in vitro digestion are similar between the LC method and the glucose oxidase method. After in vitro digestion, however, the glucose contents determined by the LC method are 11% higher for the sample prepared by the small scale α-amylase hydrolysis and 6% higher for the sample prepared by large scale α-amylase hydrolysis than those determined by the glucose oxidase method. It is possible that some of the glucose determined by the LC method is HP substituted glucose. The LC recovery results show that samples have not been lost during filtration and in the LC instrument (Table. 9).

TABLE 8
Glucose contents determined by Megazyme glucose oxidase kit.

| | Glucose % by glucose oxidase method | |
|---|---|---|
| | Cross-linked HP | Cross-linked HP |
| | starch after 1 hr α- | starch after in vitro |
| | amylase hydrolysis | digestion |
| small scale α-amylase | 2.0 | 23.0 |
| hydrolysis | | |
| large scale α-amylase | 2.8 | 28.8 |
| hydrolysis | | |

TABLE 9
Recovery analysis.

| | Total Area | | |
|---|---|---|---|
| Sample | (DP 1-13+) | mg/mL | % in solution |
| 271266 | 30967881 | 45.8 | 4.6 |
| 271267 | 32475848 | 48.1 | 4.8 |
| 271268 | 30802994 | 45.6 | 4.5 |
| 271269 | 31966278 | 47.3 | 4.7 |

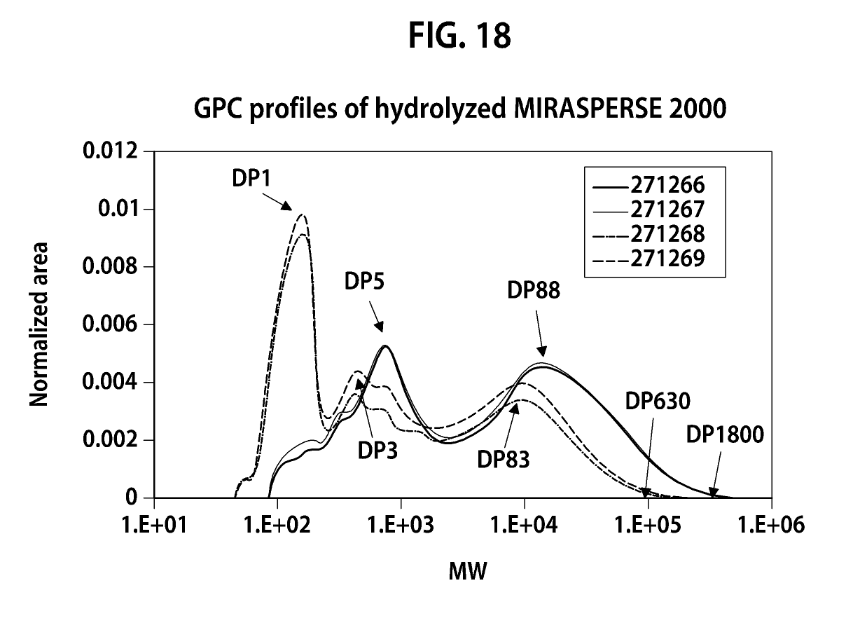

Gel permeation chromatography (GPC) profiles (FIG. 18) of α-amylase hydrolyzed cross-linked HP starch (samples 271266 and 271267) show two predominant peaks of DP5 and DP88. The DP5 peak has been shown in the HPLC with an Aminex silver-form column and the peak of DP88 is now separated in the aqueous GPC column (FIG. 18). GPC profiles of α-amylase hydrolyzed cross-linked HP starch after in vitro digestion (samples 271268 and 271269) show three predominant peaks of DP1, DP3, and DP83. The DP1 and DP3 peaks have been shown in the HPLC with an Aminex silver-form column and the peak of DP83 is now separated in the aqueous GPC column (FIG. 18).

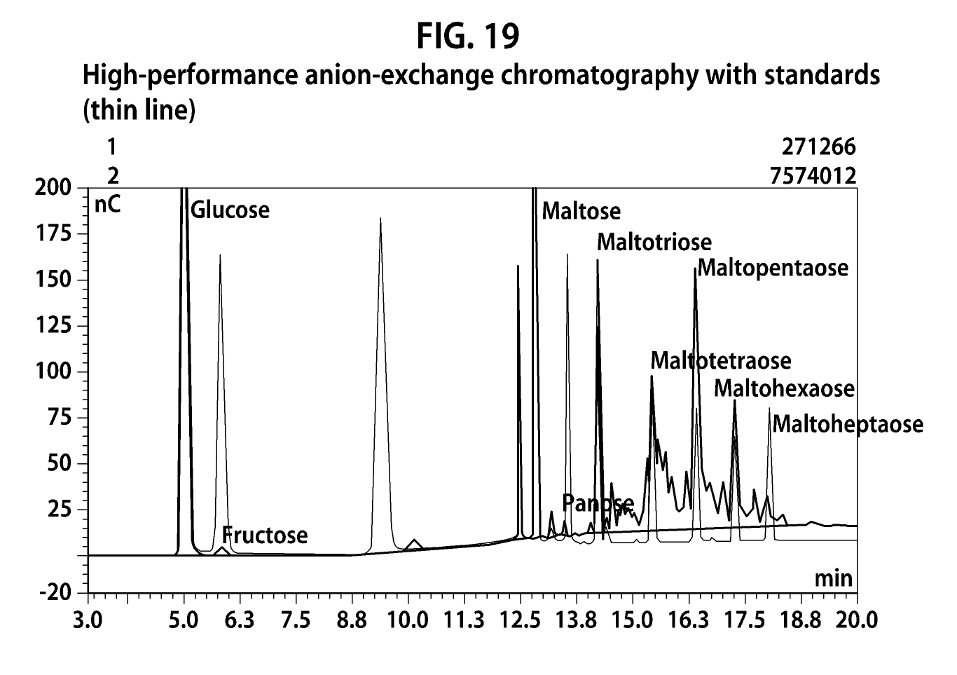

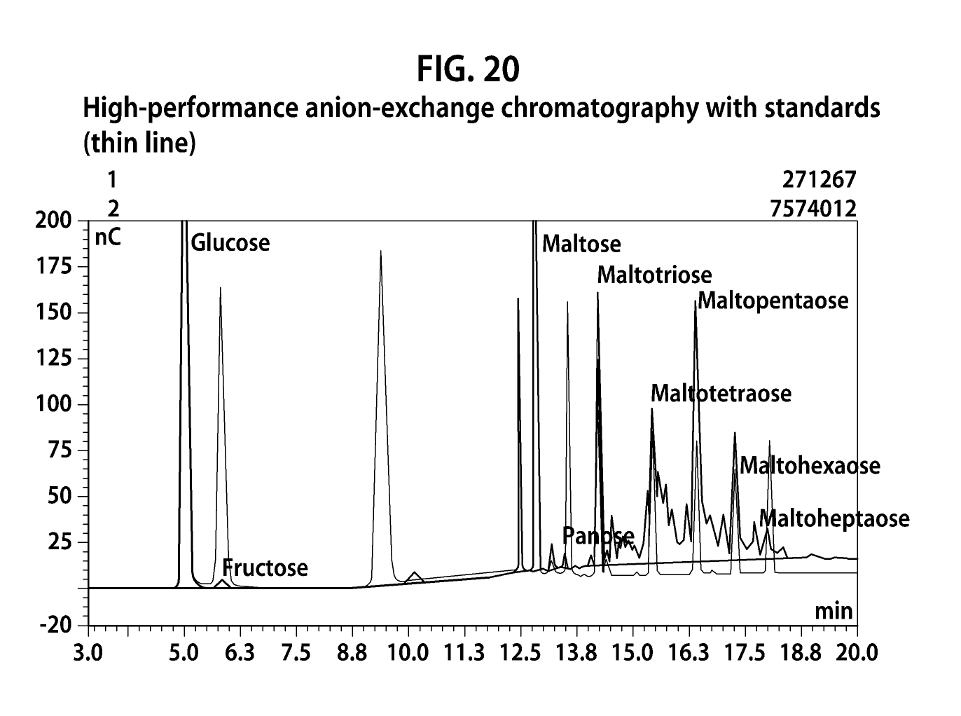

High-performance anion-exchange chromatography (HPAEC) of α-amylase hydrolyzed cross-linked HP starch (samples 271266 and 271267) show peaks of glucose, maltose, maltotriose, maltotetraose, maltopentaose, maltohexaose, and maltoheptaose (FIG. 19 and FIG. 20). The small peaks before or after maltotetraose, maltopentaose, maltohexaose, and maltoheptaose are likely the HP substituted forms of these saccharides. HPAEC of α-amylase hydrolyzed cross-linked HP starch after in vitro digestion (samples 271268 and 271269) show one peak between glucose and maltose and several peaks before and after maltotriose and maltotetraose, which are likely HP substituted forms of these saccharides.

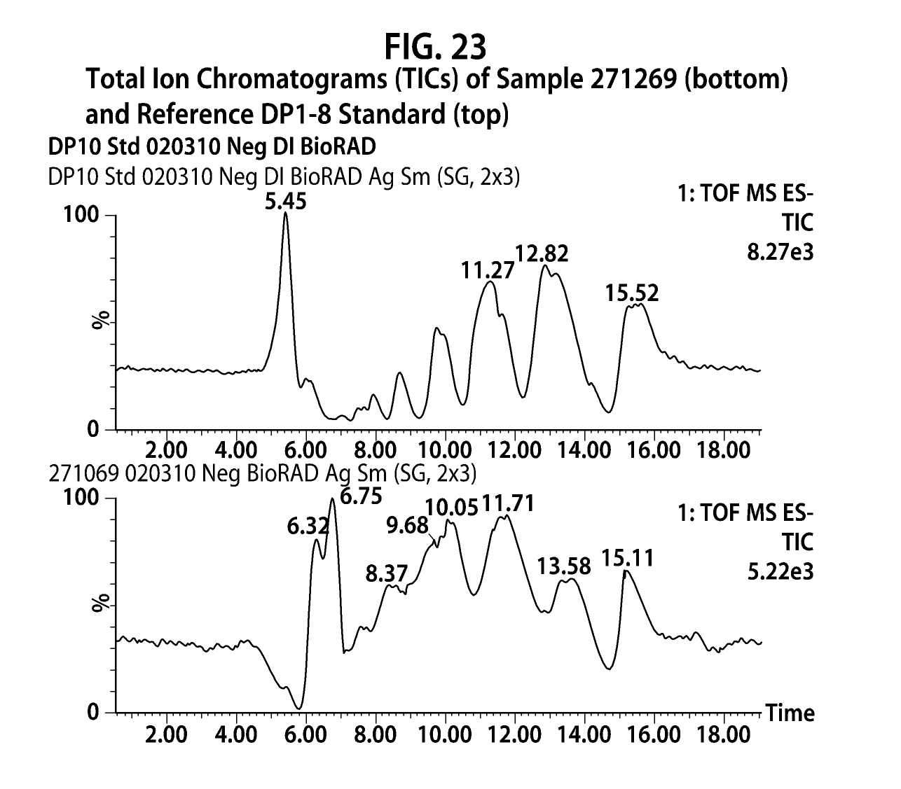

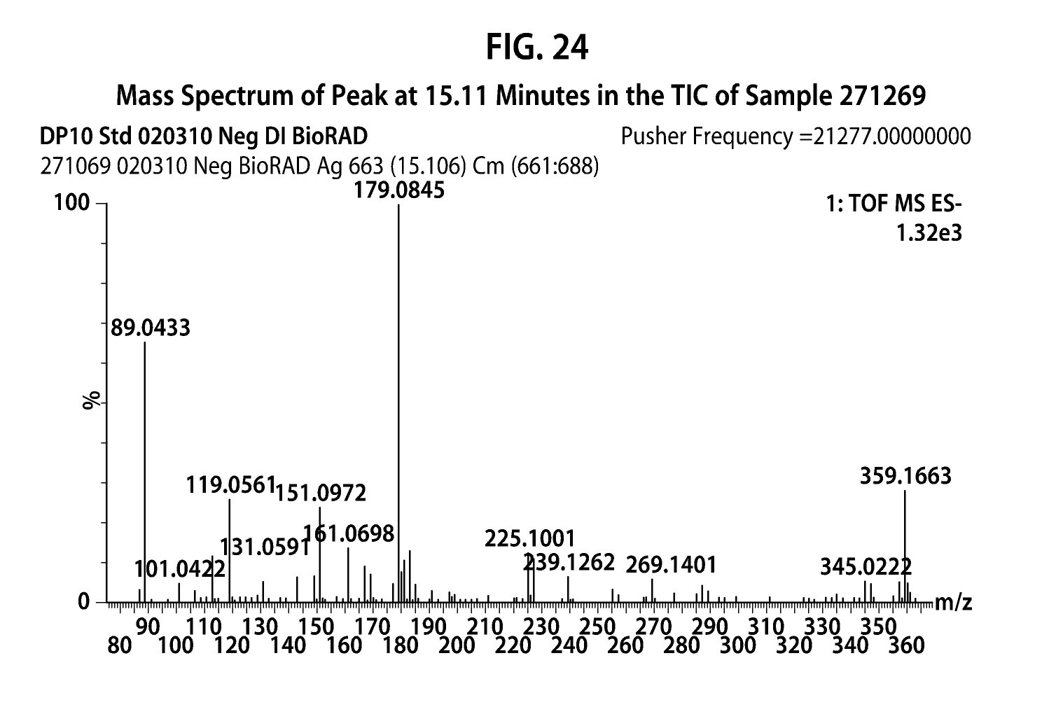

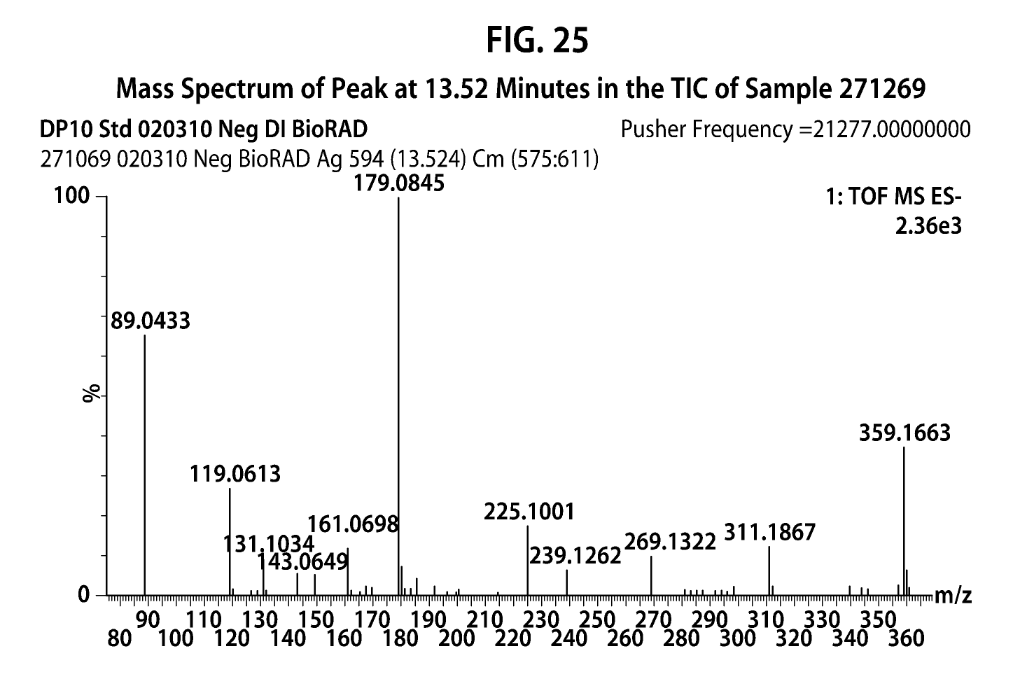

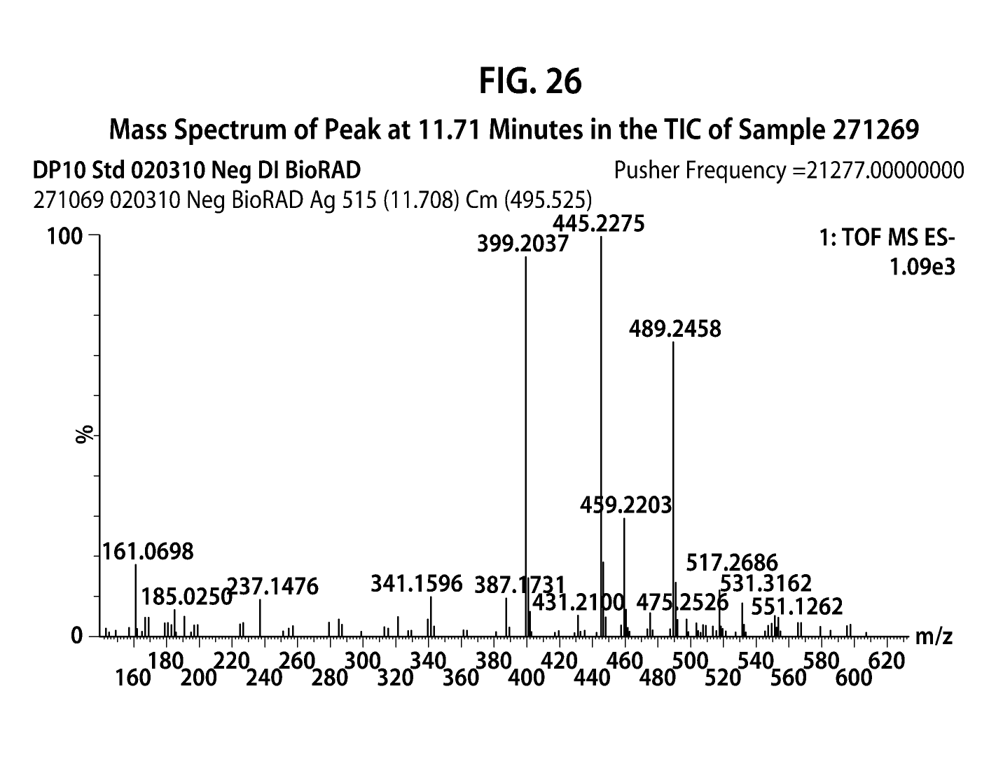

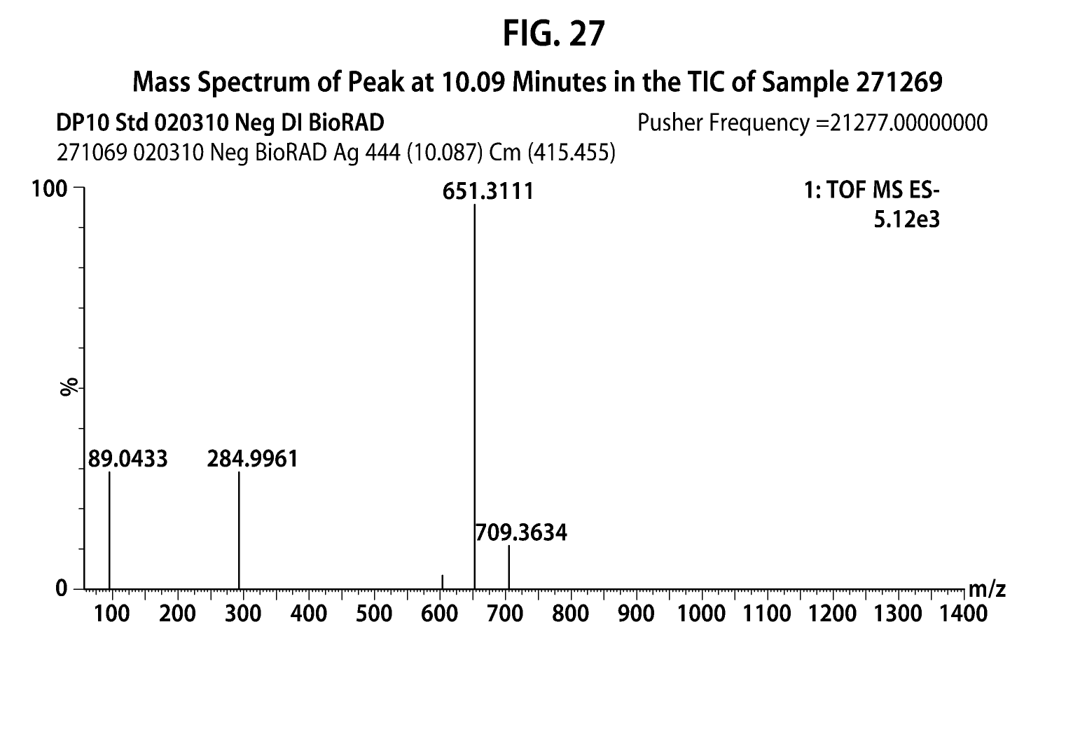

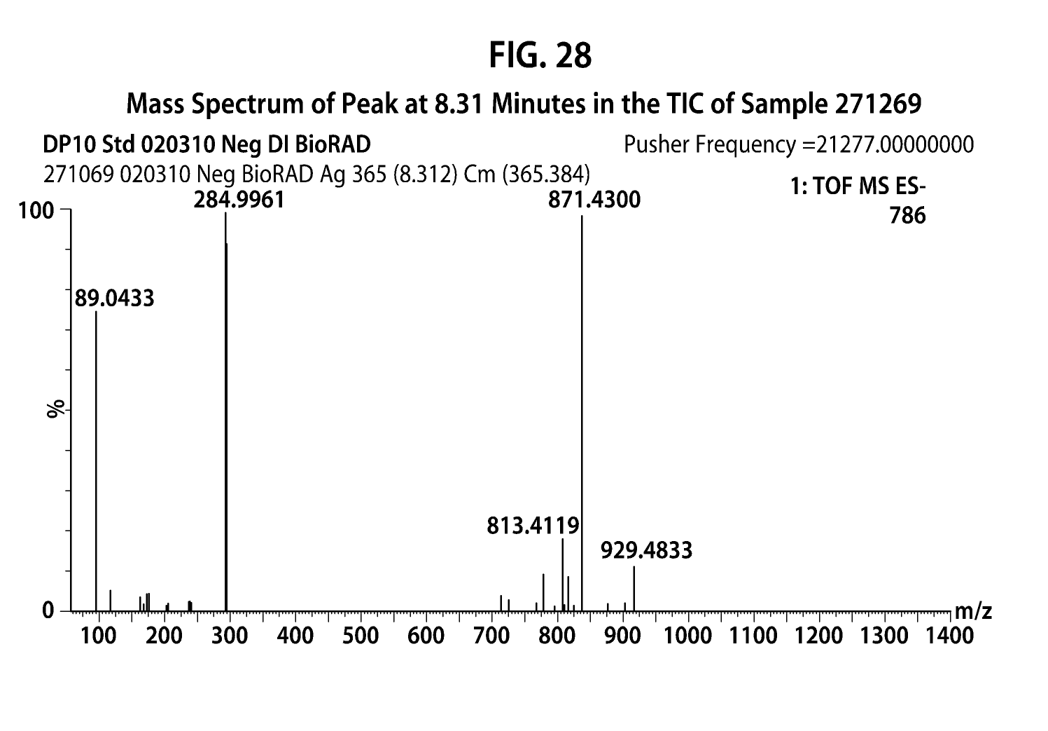

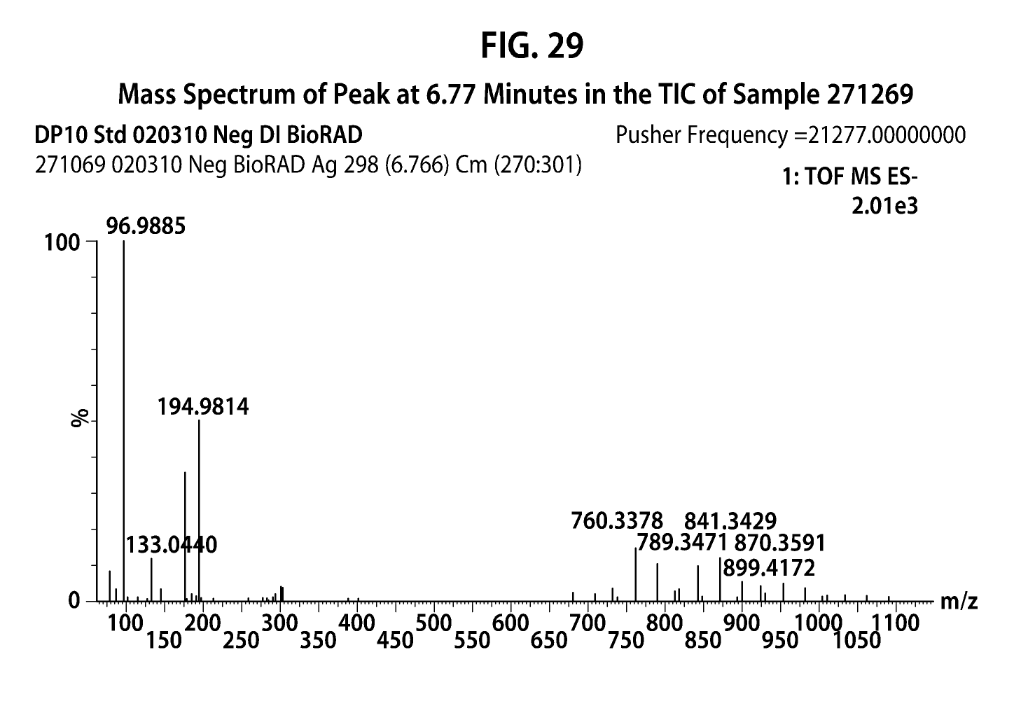

Represented in FIG. 23 are the Total Ion Chromatograms (TICs) of sample 271269 (bottom) and reference DP1-8 standard (top). Shown in FIGS. 24-29 are the mass spectra of the individual peaks in the TIC of sample 271269. The masses of the peaks in the TIC were used to identify the different forms of hydroxypropyl (HP) substitutions in the α-amylase hydrolyzed cross-linked HP starch. FIG. 24 shows masses of the peak around 15.1 minutes in the TIC. In FIG. 24, the dominant peak at 179 is the (M−1) of a glucose unit since the mass spectrum was obtained in the negative mode. The mass at 239 is attributed to HP substituted anhydro-glucose unit (HP-AGU) with two protons (237+2). This suggests that some of the glucose units that elute around 15.1 minutes are HP substituted. This probably explains why the glucose content of sample 271269 calculated by the LC method was 6% higher than the glucose content calculated by the glucose oxidase method. FIG. 25 shows the masses of the peak around 13.5 minutes in the TIC of the sample. The mass around 13.5 minutes is associated with di-hydroxypropyl-AGU. FIG. 26 is the mass spectrum of the peak around 11.7 minutes. In FIG. 26, the mass at 237 is indicative of HP-AGU, while the mass at 387 is that of tri-HP substituted AGU. HP substituted anhydro-maltose (the mass at 399), di-HP substituted anhydro-maltose (the mass at 475), and possible di-HP substituted maltose dimer (the mass at 489) were also observed in FIG. 26. In FIG. 27 the mass spectrum of the peak around 10.09 minutes in the TIC of the sample is illustrated. The predominant mass at 651 is a di-HP substituted maltotriose, which confirmed the speculation that the peak between DP3 and DP4 may be HP-maltotriose in the LC chromatogram of FIG. 17. The mass spectra of the peaks that elute at 8.3 and 6.8 minutes are represented as FIGS. 28 and 29 respectively. The masses in FIGS. 28 and 29 do not show any forms of HP-substituted α-amylase hydrolyzed high HP starch. These peaks at 8.3 and 6.8 minutes are suspected to be high molecular weight molecules that would probably require high energy for them to ionized.

### Example 4

Acarbose, a known and effective inhibitor of glucoamylase, was used as a control to quantify the inhibition of glucoamylase by α-amylase hydrolyzed NU-COL® 2004 (available from Tate & Lyle Ingredients Americas, Inc., Decatur, Ill.)—a waxy HP starch with about 13% hydroxypropyl substitution. It was determined that, on the total carbohydrate basis, a mixture of STAR-DRI® 1015 (42%) and hydrolyzate of NU-COL® 2004 (58%) showed sustained release characteristics in an in vitro digestion assay, but over 50% of the total carbohydrate was resistant to digestion.

### Experimental Methods

Sample and Inhibitor Solution Preparation:

1. Prepare sodium acetate buffer (0.1 M, pH 5.2, 0.016 M CaCl₂).

2. Prepare 8% solution in STAR-DRI® 1015 (final dry solids (ds) 3.2% in 25 mL digestive solution) (Waxy-based agglomerated 10 DE maltodextrin) using sodium acetate buffer (0.1 M, pH 5.2, 0.016 M CaCl₂).

3. Prepare 11.11% solution of Termamyl (α-amylase) hydrolyzed NU-COL® 2004:

Into a 100 mL beaker add 80 g water, 5 μL 1 M CaCl₂, and 74 μL Termamyl. Heat the water to about 60° C. and add 11.11 g ds of NU-COL® 2004 gradually to hydrolyze and dissolve the NU-COL® 2004. Adjust the pH to 6. Digest the NU-COL® 2004 for 15 minutes. Adjust the pH to 3.5 using 1 N sulfuric acid and heat to 90 C for 1 minute to kill the Termamyl. Then, adjust the pH to 5.2 and bring the total solution volume to 100 mL.

4. Prepare 11.11% solution of Clarase (α-amylase) hydrolyzed NU-COL® 2004: Into a 100 mL beaker add 80 g water, 5 μL 1 M CaCl₂, and 74 μL Clarase (activity: 40,000 SKB α-amylase unit (SKBU)/g, specific gravity 1.14 g/mL). Heat the water to about 60° C. and add 11.11 g ds of NU-COL® 2004 gradually to hydrolyze and dissolve the NU-COL® 2004. Adjust the pH to 6. Digest the NU-COL® 2004 for 15 minutes. Heat to 90° C. for 8 minutes to kill the Clarase. Adjust the pH to 5.2 and bring the total solution volume to 100 mL.

5. Weigh 20 mg of Acarbose (a commercial α-amylase inhibitor) and add to 2 mL of water to make a 10 mg/mL solution.

Preparation of Digestive Enzyme Solution:

1. Add 0.5 g pancreatin (Porcine pancreas containing many enzymes including amylase, trypsin, lipase, ribonuclease, and protease; EC No. 232-468-9, Sigma P7545, St. Louis, Mo.) to 60 mL deionized water and stir for 10 minutes.

2. Centrifuge at 3000 rpm for 10 minutes.

3. Enzyme solution: 4 mL pancreatin supernatant+1 mL AMG (300 L Novozymes)+95 mL deionized water.

Inhibition of Digestive Enzyme Tests:

1. 0.8 g STAR-DRI® 1015 and no inhibitor: Add 10 mL 8% maltodextrin and 10 mL sodium acetate buffer in a 40 mL plastic tube.

2. 1.111 g Termamyl hydrolyzed NU-COL® 2004: Add 10 mL 1.11% Termamyl hydrolyzed NU-COL® 2004 solution and 10 mL sodium acetate buffer in a 40 mL plastic tube.

3. 0.8 g STAR-DRI® 1015+1.111 g Termamyl hydrolyzed NU-COL® 2004: Add 10 mL 8% maltodextrin and 10 mL 11.11% Termamyl hydrolyzed NU-COL® 2004 solution in a 40 mL plastic tube.

4. 1.111 g Clarase hydrolyzed NU-COL® 2004: Add 10 mL 11.11% Clarase hydrolyzed NU-COL® 2004 solution and 10 mL sodium acetate buffer in a 40 mL plastic tube.

5. 0.8 g STAR-DRI® 1015+1.111 g Clarase hydrolyzed NU-COL® 2004: Add 10 mL 8% maltodextrin and 10 mL 11.11% Clarase hydrolyzed NU-COL® 2004 solution in a 40 mL plastic tube.

6. Acarbose: Add 10 mL 8% maltodextrin buffer, 10 μL Acarbose solution and 10 mL sodium acetate buffer in a 40 mL plastic tube.

Enzyme Digestion:

1. After samples are added with 5 glass balls (5 mm diameter) and equilibrated at 37° C. for 10 minutes, 5 mL of enzyme solution is added.

2. All samples are placed in a 37° C. shaker bath horizontally and shaken at 130 rpm.

3. 100 μL samples are taken at the time points: 0, 20, 30, 45, 60, 75, 90, and 120 minutes. Each sample is mixed with 2×2=4 mL 95% aqueous ethanol and vortexed.

Glucose Determination:

The glucose formed in the samples was determined by Megazyme D-Glucose kit (Wicklow, Ireland).

Megazyme's Glucose Oxidase Method:

100 μL water is mixed with 3 mL of GOPOD as a blank.

100 μL 1 mg/mL glucose standard is mixed with 3 mL of GOPOD (Chromogen reagent).

100 μL of the enzyme reacted solutions with ethanol, the standard, and the blank are each mixed with 3 mL of GOPOD.

The solutions are incubated at 50° C. for 20 minutes.

The absorbance (O.D.) is read at 510 nm against the reagent blank.

Calculation: Glucose μg/0.1 mL=(O.D. Sample/O.D. Glucose Standard, 100 μL)×100.

### Results:

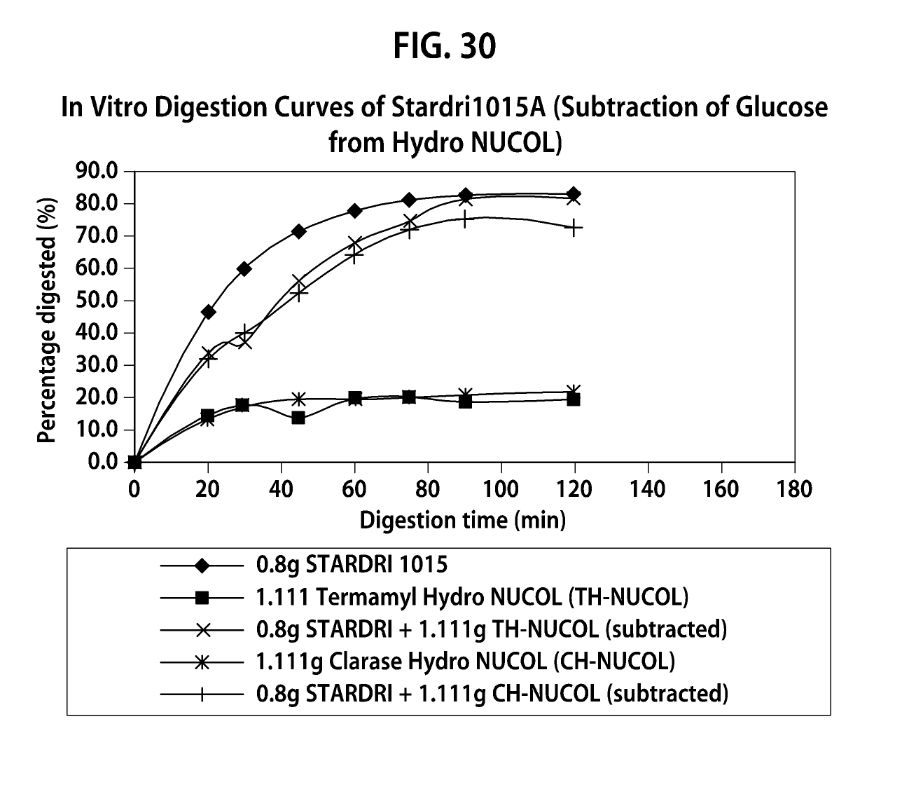

FIG. 30 shows that digestion of STAR-DRI® 1015 is rapid while Termamyl hydrolyzed NU-COL® 2004 and Clarase hydrolyzed NU-COL® 2004 are only 20% digestible. It is important to note that in vitro digestion percentages do not equal in vivo digestion percentages. FIG. 30 also shows that the rate of digestion of STAR-DRI® 1015 is reduced in the mixture of STAR-DRI® 1015 and Termamyl or Clarase hydrolyzed NU-COL® 2004 when the glucose contribution from the hydrolyzed NU-COL® 2004 has been subtracted. The decrease in the digestion rate is attributed to inhibition of amyloglucosidase by the hydrolyzed NU-COL® 2004.

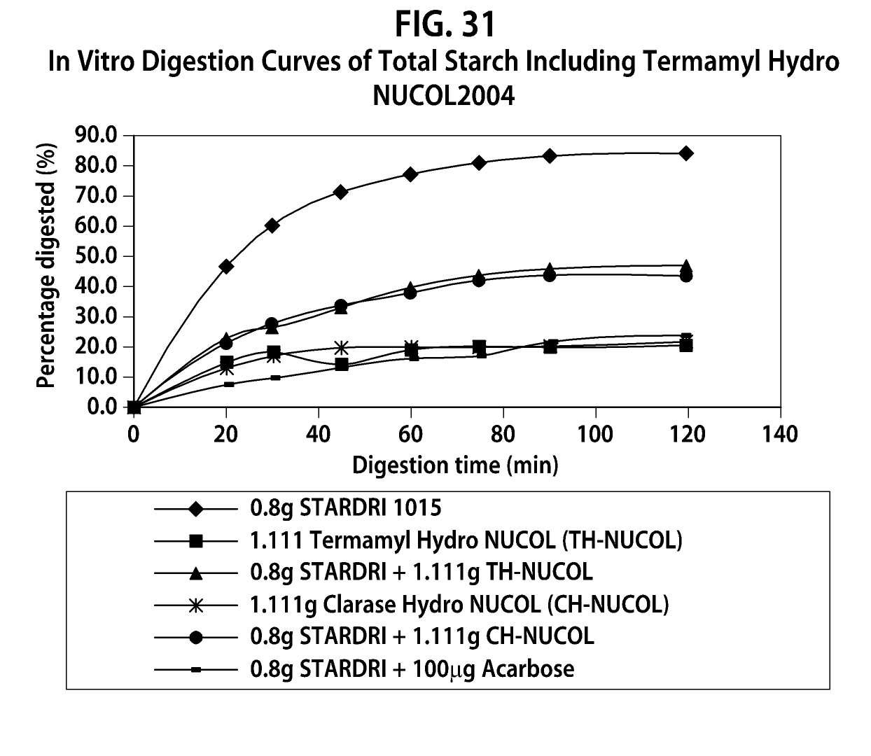

FIG. 31 shows digestion curves of the mixture of STAR-DRI® 1015 and the Termamyl or Clarase hydrolyzed NU-COL® 2004 on a total carbohydrate basis when the STAR-DRI® 1015 and the Termamyl or Clarase hydrolyzed NU-COL® 2004 are all considered to be carbohydrate. On the total carbohydrate basis, the mixtures showed sustained release characteristics in the in vitro digestion assay, but over 50% of the total carbohydrate was resistant to digestion.

### Example 5

Hydrolyzates of certain hydroxypropyl substituted starches were shown to inhibit certain digestive enzymes such as amyloglucosidase after pancreatin digestion and α-amylase hydrolysis. An α-amylase (Termamyl) was used to reduce the molecular weight of a waxy cross-linked HP starch with about 10% HP substitution and about 2% cross-linking (MIRA-SPERSE 2000®; available from Tate & Lyle Ingredients Americas, Inc., Decatur, Ill.) to produce a hydrolyzate ingredient—Termamyl hydrolyzed MIRASPERSE 2000 (TH-MS2000)—for evaluation as a sustained release carbohydrate ingredient to determine whether the enzyme-thinned starch could slow the digestion of carbohydrates and the absorption of glucose in vivo.

TH-MS2000 was evaluated by volunteers for effects on gastrointestinal tolerance, glycemic response, and modulation of maltodextrin glycemic response. TH-MS2000 was found to be well-tolerated in a single does of up to 25 g. TH-MS2000 displayed a glycemic response that was 52% of maltodextrin. In an in vivo study of comparison of glycemic response to 25 g of maltodextrin and 25 g of maltodextrin plus 10 g of TH-MS2000, the peak incremental blood glucose remained the same even though the total available carbohydrate increased by 21% with the addition of TH-MS2000. At the same time, the blood glucose level extended elevation after the peak for a prolonged time compared to the control, indicating sustained release of glucose. Paired data showed that the peak incremental blood glucose level was somewhat decreased although the total available carbohydrate increased by 21% with the addition of TH-MS2000. It is expected that the peak incremental blood glucose would be reduced if a person consumes the same amount of total available carbohydrate with TH-MS2000 than without TH-MS2000.

### Experimental Methods

All subjects participated voluntarily, signing volunteer informed consent forms for the evaluation of physiological effects for carbohydrates approved by an institutional review board and subjects received training to perform each test. Tests were performed as outlined on the consent form.

Trial 1:

Because TH-MS2000 was a new type of ingredient, gastrointestinal tolerance and adverse effects from a small dose was assessed in six volunteers. Ten grams was dissolved in water and consumed with breakfast after an overnight fast. Subjects rated their gastrointestinal symptoms over the next 24 hours on a scale of 0 (no effects) to 10 (very severe), and reported any adverse effects.

Trial 2:

Six volunteers tested the 24 hour gastrointestinal tolerance and 2 hour glycemic response of 25 g TH-MS2000 in a beverage. The beverage was made by dissolving 25 g TH-MS2000 and one package Raspberry Lemonade Crystal Light® mix in 12 ounces of water.

Trial 3:

Fourteen volunteers consumed a beverage containing 25 g of maltodextrin+10 g of TH-MS2000 (Table 1) and measured their blood glucose concentration over two hours to determine if the hydrolyzed starch could modulate glycemic response. 38.7 g of beverage mix was weighed into a 16 ounce Nalgene bottle and diluted to 355 g water with shaking to disperse.

TABLE 10
Beverage containing 25 g of maltodextrin and 10 g of TH-MS2000

| Ingredient | Per Serving (g) | % | Batch (g) |
|---|---|---|---|
| TH-MIRASPERSE 2000 | 10.36 | 26.79 | 187.54 |
| STAR-DRI 1015A Maltodextrin | 26.32 | 68.04 | 476.26 |
| Crystal Light ® Raspberry | 2.00 | 5.17 | 36.20 |
| Lemonade mix | | | |
| | 38.68 | 100.00 | 700.00 |

### Results and Discussion

Trial 1:

Table 2 shows 24-hour tolerance data from six subjects after drinking a beverage containing 10 g TH-MS2000. The majority of volunteers rated the severity of bloating, flatulence, cramping, and stomach noise as null or mild. No adverse effects were noted.

TABLE 11
Severity of 24 hour gastrointestinal effects
from 10 g TH-MS2000 consumed in a beverage.

| | Bloating | Flatulence | Cramp | Stomach Noise |
|---|---|---|---|---|
| | Severity | Severity | Severity | Severity |
| | 0 | 1 | 0 | 0 |
| | 0 | 1 | 0 | 0 |
| | 2 | 0 | 0 | 0 |
| | 1 | 4 | 2 | 2 |
| | 0 | 0 | 0 | 0 |
| | 0 | 2 | 0 | 0 |
| Mean | 0.5 | 1.33 | 0.33 | 0.33 |
| SD | 0.34 | 0.61 | 0.33 | 0.33 |

Trial 2:

After consuming 25 g, subjects reported TH-MS2000 to be well-tolerated. The severity of gastrointestinal effects were rated as mild for each symptom (Table 12).

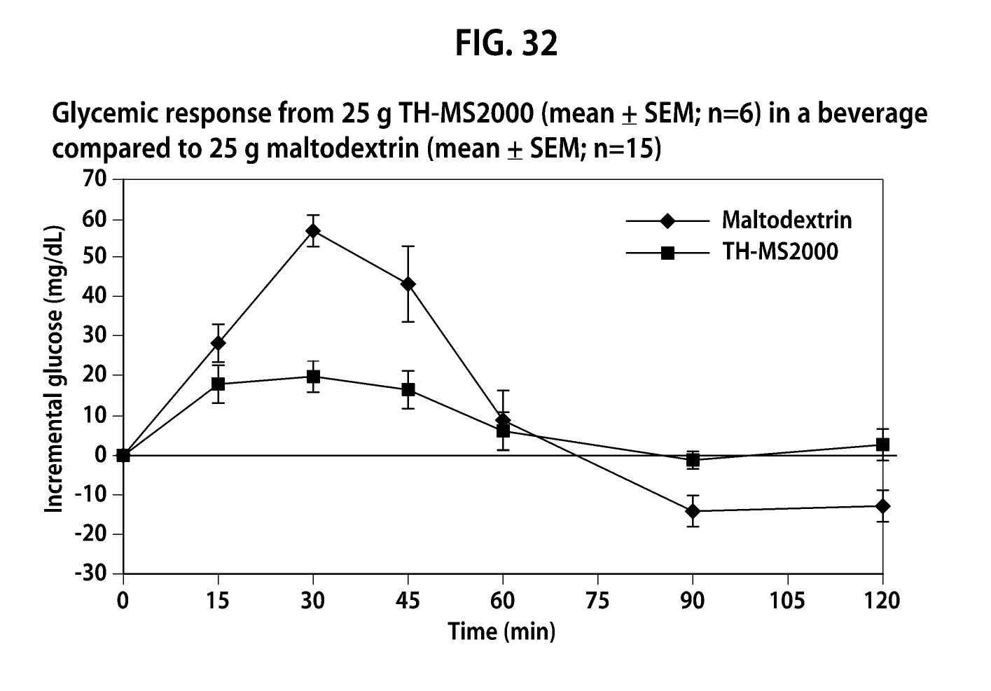

FIG. 32 shows the glycemic response of 25 g TH-MS2000 and blood glucose data for 25 g maltodextrin. Compared to the fully available carbohydrate of maltodextrin, TH-MS2000 yielded a lower peak blood glucose level and extended the time of blood glucose elevation above baseline. The relative glycemic response (RGR) of TH-MS2000 was 52 (Table 13). Analysis of TH-MS2000 and its in vitro digestion products showed that there are substantial amounts of unsubstituted free glucose and glucose oligomers, so the glycemic response was not surprising.

TABLE 12
Severity of 24 hour gastrointestinal effects
from 25 g TH-MS2000 consumed in a beverage.

| | Bloating | Flatulence | Cramp | Stomach Noise |
|---|---|---|---|---|
| | Severity | Severity | Severity | Severity |
| | 3 | 3 | 0 | 0 |
| | 3 | 1 | 2 | 4 |
| | 4 | 2 | 0 | 3 |
| | 0 | 2 | 0 | 0 |
| | 0 | 0 | 0 | 0 |
| | 0 | 0 | 0 | 0 |
| Mean | 1.67 | 1.33 | 0.33 | 1.17 |
| SD | 0.76 | 0.49 | 0.33 | 0.75 |

TABLE 13
Incremental area under the curve (IAUC) and
relative glycemic response (RGR) for the glycemic
response of TH-MS2000 and maltodextrin.

| Sample | IAUC (mean ± SD) | RGR |
|---|---|---|
| 25 g maltodextrin | 2239 ± 674 | 100 |
| 25 g TH-MS2000 | 1171 ± 539 | 52 |
| 10 g TH-MS2000 (theoretical) | 468 | |

Trial 3:

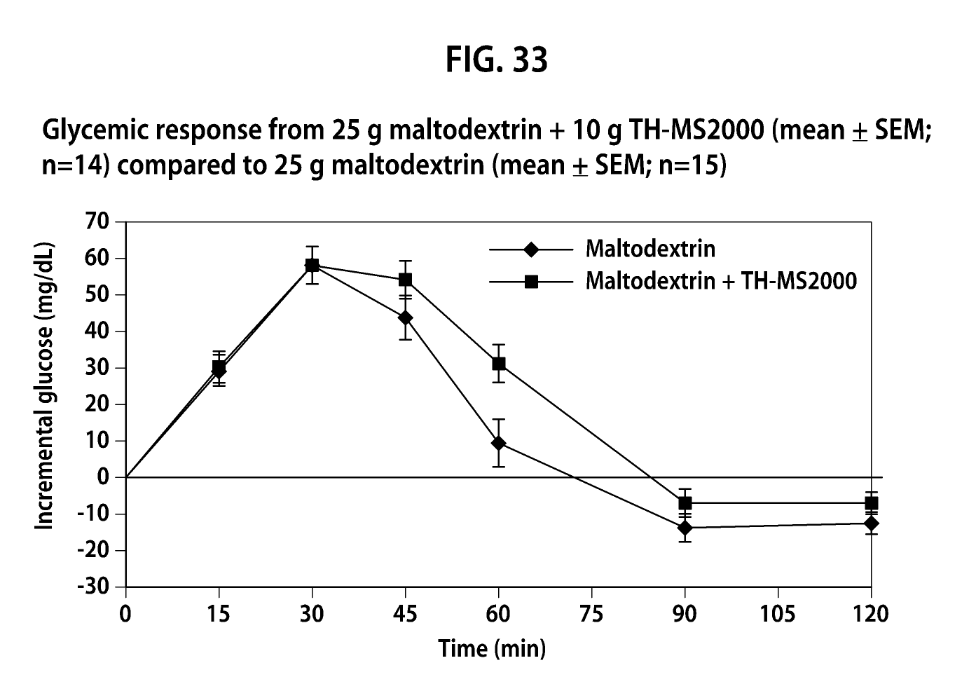

The effect of 10 g TH-MS2000 on the glycemic response of 25 g maltodextrin was tested in 14 volunteers (FIG. 33). The peak incremental blood glucose remained the same even though the total available carbohydrate increased by 21% with the addition of TH-MS2000 [(10 g×52%)/25]. Table 14 shows that the incremental area under the curve from maltodextrin+TH-MS2000 was greater than that from maltodextrin alone because of an increase of total available carbohydrate with the addition of TH-MS2000. At the same time, the blood glucose level extended elevation after the peak for a prolonged time compared to the control, which indicated sustained release of glucose.

TABLE 14
Incremental area under the curve (IAUC) and relative glycemic
response (RGR) for glycemic response of 25 g maltodextrin +
10 g TH-MS2000 (n = 14) compared to 25 g maltodextrin (n = 15).

| Sample | IAUC (mean ± SD) | RGR |
|---|---|---|
| Maltodextrin | 2239 ± 674 | 100 |
| Maltodextrin + TH-MS200 | 2804 ± 811 | 125 |

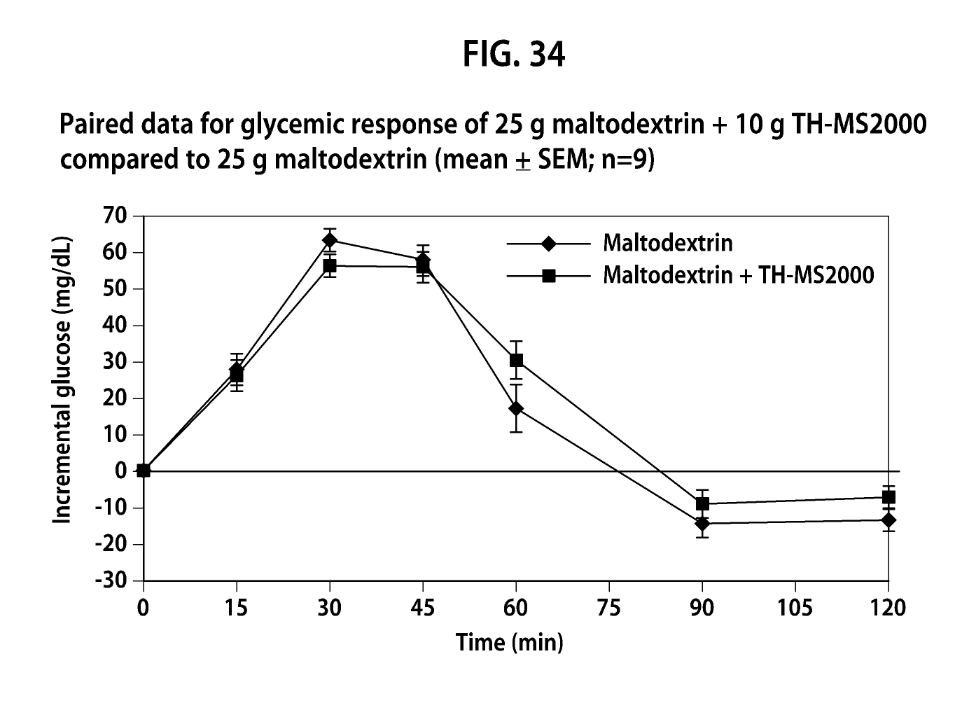

This comparison was not paired, so the glycemic response curves were reexamined using only volunteers from whom data sets for both maltodextrin and maltodextrin+TH-MS2000 were available. The curves for those nine volunteers are shown in FIG. 34 and Table 15. The paired data showed that the peak incremental blood glucose level was somewhat decreased although the total available carbohydrate increased by 21% with addition of TH-MS2000. These results indicate that the peak incremental blood glucose may be reduced if a person consumes the same amount of total available carbohydrate with TH-MS2000 than without TH-MS2000.

TABLE 15
Incremental area under the curve (IAUC) and relative glycemic
response (RGR) for glycemic response of 25 g maltodextrin +
10 g TH-MS2000 compared to 25 g maltodextrin (n = 9).

| A. | Sample | B. | IAUC (mean ± SD) | C. | RGR |
|---|---|---|---|---|---|
| D. | Maltodextrin | E. | 2418 ± 821 | F. | 100 |
| G. | Maltodextrin + | H. | 2702 ± 744 | I. | 112 |
| | TH-MS200 | | | | |

What is claimed is:

1. A food ingredient composition comprising (i) the hydrolysis products of an α-amylase hydrolyzed hydroxypropyl substituted starch and (ii) a rapidly digestible starch, wherein the hydroxypropyl substituted starch has at least about 5% hydroxypropyl substitution before hydrolysis, and wherein the ratio by weight on a dry solids basis of the hydrolysis products to the rapidly digestible starch is from about 20% to about 80% of the hydrolysis products to from about 80% to about 20% of rapidly digestible starch.

2. The food ingredient composition of claim 1 wherein the hydroxypropyl substituted starch is from corn.

3. The food ingredient composition of claim 1 wherein the hydroxypropyl substituted starch is a crosslinked starch.

4. The food ingredient composition of claim 1 wherein the hydroxypropyl substituted starch comprises at least about 30% fiber before hydrolysis.

5. The food ingredient composition of claim 1 wherein the hydroxypropyl substituted starch is a waxy starch that has about 13% hydroxypropyl substitution before hydrolysis.

6. The food ingredient composition of claim 3 wherein the crosslinked hydroxypropyl substituted starch is a waxy starch that has about 10% hydroxypropyl substitution and about 2% crosslinking before hydrolysis.

7. A food product comprising (i) the hydrolysis products of an α-amylase hydrolyzed hydroxypropyl substituted starch and (ii) a rapidly digestible starch, wherein the hydroxypropyl substituted starch has at least about 5% hydroxypropyl substitution before hydrolysis, and wherein the ratio by weight on a dry solids basis of the hydrolysis products to the rapidly digestible starch in the food product is from about 20% to about 80% of the hydrolysis products to from about 80% to about 20% of rapidly digestible starch.

8. The food product of claim 7 wherein the hydroxypropyl substituted starch is from corn.

9. The food product of claim 7 wherein the hydroxypropyl substituted starch is a crosslinked starch.

10. The food product of claim 7 wherein the hydroxypropyl substituted starch comprises at least about 30% fiber before hydrolysis.

11. The food product of claim 7 wherein the hydroxypropyl substituted starch is a waxy starch that has about 13% hydroxypropyl substitution before hydrolysis.

12. The food product of claim 9 wherein the crosslinked hydroxypropyl substituted starch is a waxy starch that has about 10% hydroxypropyl substitution and about 2% crosslinking before hydrolysis.

13. A method of preparing a sustained release carbohydrate food ingredient composition, the method comprising combining the hydrolysis products of (i) an α-amylase hydrolyzed hydroxypropyl substituted starch with (ii) a rapidly digestible starch, wherein the hydroxypropyl substituted starch has at least about 5% hydroxypropyl substitution before hydrolysis, and wherein the ratio by weight on a dry solids basis of the hydrolysis products to the rapidly digestible starch is from about 20% to about 80% of the hydrolysis products to from about 80% to about 20% of rapidly digestible starch.

14. The method of claim 13 wherein the hydroxypropyl substituted starch is from corn.

15. The method of claim 13 wherein the hydroxypropyl substituted starch is a crosslinked starch.

16. The method of claim 13 wherein the hydroxypropyl substituted starch comprises at least about 30% fiber before hydrolysis.

17. The food product of claim 13 wherein the hydroxypropyl substituted starch is a waxy starch that has about 13% hydroxypropyl substitution before hydrolysis.

18. The food product of claim 15 wherein the crosslinked hydroxypropyl substituted starch is a waxy starch that has about 10% hydroxypropyl substitution and about 2% crosslinking before hydrolysis.

19. A method of preparing a food product, the method comprising including (i) the hydrolysis products of an α-amylase hydrolyzed hydroxypropyl substituted starch and (ii) a rapidly digestible starch in a food product, wherein the hydroxypropyl substituted starch has at least about 5% hydroxypropyl substitution before hydrolysis, and wherein the ratio by weight on a dry solids basis of the hydrolysis products to the rapidly digestible starch in the food product is from about 20% to about 80% of the hydrolysis products to from about 80% to about 20% of rapidly digestible starch.

20. The method of claim 19 wherein the hydroxypropyl substituted starch is from corn.

21. The method of claim 19 wherein the hydroxypropyl substituted starch is a crosslinked starch.

22. The method of claim 19 wherein the hydroxypropyl substituted starch comprises at least about 30% fiber before hydrolysis.

23. The method of claim 19 wherein the hydroxypropyl substituted starch is a waxy starch that has about 13% hydroxypropyl substitution before hydrolysis.

24. The method of claim 21 wherein the crosslinked hydroxypropyl substituted starch is a waxy starch that has about 10% hydroxypropyl substitution and about 2% crosslinking before hydrolysis.

25. A digestive enzyme inhibitor comprising the hydrolysis products of an α-amylase hydrolyzed hydroxypropyl substituted starch, wherein the hydroxypropyl substituted starch is a waxy corn starch comprising at least about 30% fiber before hydrolysis and wherein the hydroxypropyl substituted starch has about 13% hydroxypropyl substitution before hydrolysis.

26. A digestive enzyme inhibitor comprising the hydrolysis products of an α-amylase hydrolyzed hydroxypropyl substituted starch, wherein the hydroxypropyl substituted starch is a crosslinked waxy corn starch comprising at least about 30% fiber before hydrolysis and wherein the hydroxypropyl substituted starch has about 10% hydroxypropyl substitution and about 2% crosslinking before hydrolysis.
